(19) United States
(12) Patent Application Publication
(10) Pub. No.: US 2022/0338420 A1
(43) Pub. Date: Oct. 27, 2022

(54) CONTROL SYSTEMS AND METHODS FOR MANAGING A LOCALIZED GROWING ENVIRONMENT

(71) Applicant: Soli Organic Inc., Harrisonburg, VA (US)

(72) Inventor: Ulf Jönsson, Tvaaker (SE)

(21) Appl. No.: 17/726,032

(22) Filed: Apr. 21, 2022

Related U.S. Application Data
(60) Provisional application No. 63/177,702, filed on Apr. 21, 2021.
(60) Provisional application No. 63/190,050, filed on May 18, 2021.
(60) Provisional application No. 63/190,053, filed on May 18, 2021.
(60) Provisional application No. 63/208,650, filed on Jun. 9, 2021.
(60) Provisional application No. 63/208,652, filed on Jun. 9, 2021.

(51) Int. Cl. A01G 7/04; A01G 31/02; A01G 9/24; A01G 9/18

(52) U.S. Cl. CPC A01G 7/045; A01G 31/02; A01G 9/246; A01G 9/247; A01G 9/249; A01G 9/18; A01G 2031/006

(57) ABSTRACT

Disclosed herein are control systems and methods for managing and controlling the localized environment for growing plants in an indoor organic environment. The methods and systems provide for optimizing the climate at the localized level beneath the plant canopy to ensure the climate promotes plant growth. The control system controls the environment by monitoring, adjusting, and managing various systems within the indoor growing environment such as an air circulation system, a temperature control system, an irrigation system, a nutrition delivery system, a lighting system, and a sensor system, either individually or in various combinations.

### CROSS-REFERENCE TO RELATED APPLICATIONS

This application claims priority to the following: pending U.S. Provisional Patent Application Ser. No. 63/177,702, titled “Apparatus and Method for Management of Localized Environment for Indoor Growing Facilities,” filed on Apr. 21, 2021; pending U.S. Provisional Patent Application Ser. No. 63/190,050, titled “Systems and Methods for Automated Management of Environmental Characteristics and Microorganisms to Produce and Distribute Organic Nutrients for Growing Plants,” filed on May 18, 2021; pending U.S. Provisional Patent Application Ser. No. 63/190,053, titled “Systems and Methods for Managing Oxygen Levels and Microorganisms to Produce Organic Nutrients,” filed on May 18, 2021; pending U.S. Provisional Patent Application Ser. No. 63/208,650, titled “Control Systems for Efficient Nutrient Delivery Production for Indoor Organic Growing,” filed on Jun. 9, 2021; and pending U.S. Provisional Patent Application Ser. No. 63/208,652, titled “Control Systems and Methods for Managing a Localized Growing Environment for Organic Indoor Growing,” filed on Jun. 9, 2021; each of which are expressly incorporated by reference herein in its entirety.

### TECHNICAL FIELD

The present disclosure generally relates to control systems and methods for managing parameters and characteristics of localized growing environment. More specifically, the present disclosure relates to the application of control systems and sensors and other equipment to monitor various parameters and characteristics of a localized growing environment and adjust such parameters and characteristics as required to facilitate and maximize the localized growing environment.

### BACKGROUND

The development of controlled environment agriculture, such as greenhouses and indoor farming, has contributed benefits to industrial food production systems. For instance, some controlled environment agriculture systems, such as vertical indoor farming, offer benefits over outdoor production systems, such as faster and more efficiently controlled production, year-round growing season, and protection against adverse weather conditions. While these benefits have improved global food production, many of these conventionally controlled environment agriculture systems lack efficient methods for achieving quality production level for indoor growing, and especially organic growing, at a commercial level. Disclosed herein are novel control systems and methods applicable for use in controlled environment agriculture.

The disclosure provided in the background section should not be assumed to be prior art merely because it is mentioned in or associated with the background section. The background section may include information that describes one or more aspects of the subject technology.

### SUMMARY

The present disclosure provides systems and methods for controlling various operations in an indoor growing environment, including the growing of plants in soil. In certain embodiments, a controller monitors, adjusts, and manages various systems within the indoor growing environment such as, but not limited to, an air circulation system, a temperature control system, an irrigation system, a nutrition delivery system, a lighting system, a sensor system, and other well-known systems in the industry, either individually or in various combinations. In certain embodiments, the controller monitors and manages such systems, either individually or in various combinations, to maintain an efficient grow environment for indoor organic growing.

In one embodiment, the indoor growing environment is divided into multiple zones for growing multiple types of plants where each type of plant includes specific parameters for optimal growing. In an embodiment, the controller monitors and manages (e.g., adjusts as necessary) the various systems to control conditions in each of the multiple zones particular to the corresponding type of plant. In certain embodiments, the controller monitors and manages the various systems to provide efficient production of nitrate and other nutrients for indoor organic growing in the indoor growing environment. In other embodiments, the controller monitors and manages the humidity and temperature around certain plants or specific plants to maximize the conditions for growing the plants and minimize growth of fungus or other unwanted bacteria.

In one embodiment, an environment management system for indoor plant growing includes a micro environment control system configured to control a localized environment proximate to small groups or individual cultivation pots. The localized environment includes the environment around the cultivation pot, the roots of the plant growing in the pot, the stem of the plant, and the branches and leaves of the plant extending upward and outward. The environment management system also includes a control system configured to measure certain factors of the localized environment and adjust that localized environment as needed to optimize growing conditions. In other embodiments, a method of operating an environment management system includes growing plants in an indoor growing facility and collecting and analyzing environment data to determine optimal growing conditions. The method also includes determining localized environment conditions and updating the operation of the environment management system based on the determination of the localized environment conditions.

In one embodiment, a nitrate forming and delivery system efficiently mimics natural processes to form nitrate from nitrogen and bacteria and delivers such nitrate to the soil used for growing plants. Such a nitrate forming and delivery system includes stacked layers of biofilter media that are separated by support structures. The biofilter media is a generally a honeycombed-shaped structure that provides a substantial surface area. The biofilter media can be formed or fabricated from a plastic material.

Bacteria useful in converting nitrogen rich materials (such as ammonia and ammonium) to nitrate, such as for example, Nitrosomonas and Nitrobacter, are grown on the biofilter media in a controlled manner. Such growth is promoted until all or substantially all of the surface area of the biofilter media is covered with such bacteria. A stream of water and nitrogen rich material is cascaded over the biofilter media, and nitrate are formed. The nitrogen rich material can be generated by the decomposition of organic matter through its interaction with a bacteria or fungi useful for that purpose. The system maintains a separation between the various bacteria used in the system due to differing multiplication rates and are closely controlled to maintain balance in the system. The system also limits or eliminates the use and presence of carbon within the system. Such a process is aerobic, where the oxidation of ammonia and ammonium takes place in the presence of oxygen. Therefore, oxygen is present about the biofilter media.

The nitrate are carried away with the flow of the water, which can be directed to a holding tank prior to use in irrigating soil and delivering organic nitrate to the growing environment. When in a holding tank, the nitrate rich fluid can be measured for pH level and subsequently diluted or concentrated to achieve the most effective pH level prior to irrigating the soil of a growing area. The nitrate rich fluid can be maintained generally in a liquid form or can be converted to a slurry prior to use in the growing environment.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. It should be noted that although various embodiments may be described herein with reference to particular settings, these are examples only and are not to be considered limiting. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 schematically illustrates an example indoor growing environment, according to certain embodiments of the disclosure.

FIG. 2 is a block diagram illustrating an example control system according to certain embodiments of the disclosure.

FIG. 3 schematically illustrates an example controller of the control system of FIG. 2, according to certain embodiments of the disclosure.

FIGS. 4A-4K are example illustrations associated with the control system, according to certain embodiments of the disclosure.

FIG. 5 illustrates exemplary cultivation pots.

FIG. 6 illustrates exemplary plates or trays for supporting cultivation pots.

FIG. 7 schematically illustrates an exemplary indoor plant growing facility with an environment management system.

FIG. 8 is a flow diagram of an exemplary method for growing plants using the environment management system of FIG. 7.

FIG. 9 illustrates example lighting conditions for plant growing.

FIG. 10 is block diagram illustrating an example computer system with which the controller can be implemented, according to certain embodiments of the disclosure.

FIG. 11 is a schematic depicting an overview of the nitrogen cycle as it occurs in nature.

FIG. 12 is a schematic illustration of an exemplary nitrate forming and delivery system as disclosed and described herein.

FIG. 13 is a schematic illustration of an exemplary nitrate forming and delivery system constructed on an industrial scale.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The disclosed systems and methods provide solutions to improve traditional indoor growing systems and methods. For example, the disclosed systems and methods provide a controller to monitor and manage various systems of an indoor growing environment in a manner that is customizable to meet the specific needs of that indoor growing environment and zones within that indoor growing environment. In certain embodiments, the growing environment can be discretely controlled within a zone. A zone can be populated by a series of trays, each holding several seedlings/plants. The controller and applicable sensors can be arranged and positioned to control environmental characteristics, such as humidity and temperature, for each tray of plants, or even for individual plants. It will be understood that sensors can be arranged to measure and monitor certain environmental characteristic and provide such measurements to the controller. The controller can receive and analyze such measurements and make appropriate adjustments to modify and/or control such environmental characteristics, thus, controlling the environmental conditions and provide the plants with the optimal growing environment.

The controller regulates various systems to ensure efficient indoor growing capabilities and can monitor and manage a wide variety of plant types at the same time all within the same indoor growing environment or facility. In particular, the controller monitors and manages various systems to control parameters such as, but not limited to, temperature, humidity, air flow rate, oxygen levels, irrigation rate, nutritional delivery, and other well-known parameters in the industry, specific to each particular plant type being grown within the indoor growing environment. In particular embodiments, for indoor organic growing, the controller monitors and manages various systems to provide: efficient production of nutrients, such as nitrate and phosphorus; effective lighting; suitable temperature ranges; suitable humidity ranges; and sufficient moisture delivery to the roots of the plant. Furthermore, the controller is configured to learn from or train on monitored data and to analyze and interpret the monitored data to determine appropriate subsequent actions for controlling various systems for the indoor growing environment.

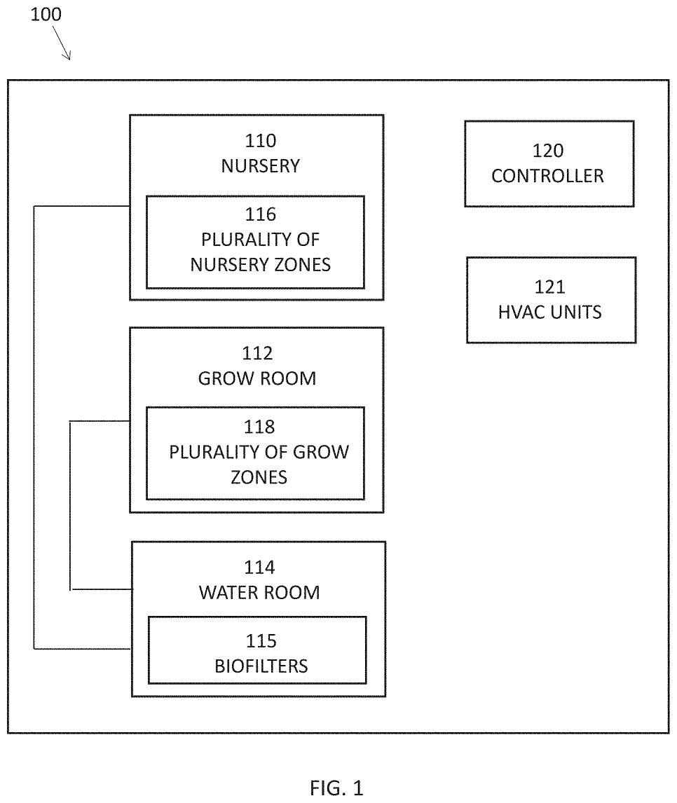

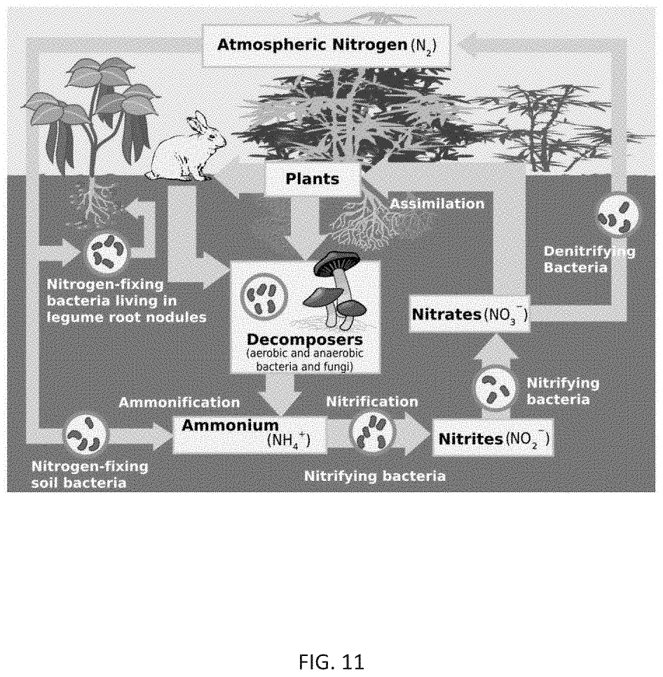

In one embodiment, a feedback and control loop is used. FIG. 1 illustrates an exemplary indoor growing environment or system 100 for indoor growing of various plants, such as vegetables and herbs. The indoor growing environment or system 100 includes, for example, a nursery 110, a grow room 112, and a water room 114. In certain embodiments, the nursey 110 can be divided into a plurality of nursery zones 116 so that each nursey zone of the plurality of nursery zones 116 is dedicated to a particular plant type or herb type. In certain embodiments, the grow room 112 can similarly be divided into a plurality of grow zones 118 so that each grow zone of the plurality of grow zones 118 is dedicated to a particular plant type of herb type. The nursery zones 116 and grow zones 118 can each be subdivided into discrete areas associated with a group of plants, which can be positioned withing a tray. The water room 114 includes a nitrate forming and delivery system that includes one or more biofilters or a biofilter assembly 115 for the production of nutrient rich irrigation liquids and slurries as will be discussed later (FIGS. 11-13).

The indoor growing environment or system 100 further includes a controller 120 and one or more heating, ventilation, and air conditioning (“HVAC”) units 121. The controller 120 monitors and managing the environmental conditions of the indoor growing environment or system 100 including the nursery 110, the grow room 112, and the water room 114. The controller 120 can manage the environmental conditions through the use of HVAC units 121 providing heated or cooled air along with general air flow to the nursery 110, grow room 112, and/or water room 114.

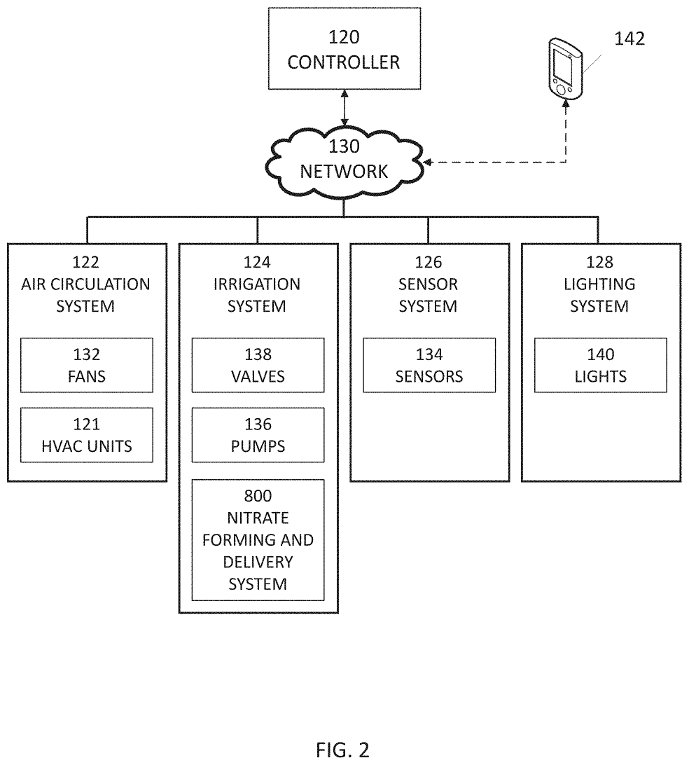

With reference to FIG. 2, the controller 120 controls operations of the indoor growing environment 100 through a number of systems (sub-systems) in communication with the controller 120 through a network 130. For example, the controller 120 can communicate with and control an air circulation system 122, an irrigation system 124, a sensor system 126, a lighting system 128, and a user device 142. The air circulation system 122 can include one or more HVAC units 121 and one of more fans 132. The HVAC units 121 and fans 132 can be arranged to deliver heated or cooled air generally to the nursery 110, grow room 112, or water room 114 or deliver conditioned air to specific nursery zones 116 or grow zones 118. In addition to delivery conditioned air (i.e., temperature controlled warm or cool air), the air circulation system 122 can also provide air at a specific flow rate to better manage the environmental conditions in the growing environment 100. As previously described and further detailed herein, the air circulation system 122 can be arranged to deliver conditioned air at certain flow rates to discrete areas within nursery zones 116 or grow zones 118 or to individual plants.

The sensor system 126 can include a plurality of various sensors distributed throughout the nursery 110, grow room 112, or water room 114 to measure a variety of environmental conditions. For example, sensors 134 can monitor temperature, humidity, light levels, moisture level in soil, pH level of water and nutrient streams, and any number of environmental conditions affecting the growth of plants. The sensors 134 provide such measurements to the controller 120. The controller 120 analyzes such measurements, determines the need for any adjustments to the environmental conditions, and directs the applicable system to make such an adjustment.

The irrigation system 124 includes a plurality of pumps 136 and valves 138 that are controlled by the controller 120 to deliver water and nutrients to plants in the nursery 110 and grow room 112. As with other embodiments, such water and nutrient deliver can be controlled generally at the nursery 110 or grow room 112 level, at the nursery zone 116 or grow zone 118 level, or a more discrete level applied to a group of plants or even a single plant. The irrigation system 124 may include or be operatively coupled to a nitrate forming and delivery system 800 to enrich plants in the nursery zone 116 and/or the grow zone 118 as will be discussed later (FIGS. 11-13).

The lighting system 128 includes a plurality of lights 140, and the controller 120 communicates with the lighting system 128 to control the duration and level of light applied to plants in the nursery 110 and grow room 118.

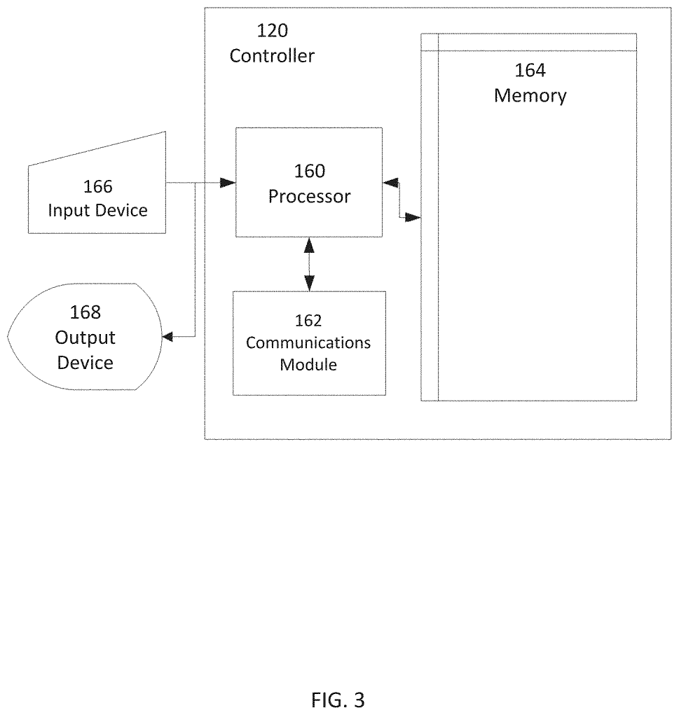

With reference to FIG. 3, the controller 120 can be any device having an appropriate processor, memory, and communications capability for communicating with the air circulation system 122, the irrigation system 124, the sensor system 126, the lighting system 128, and user device 142. For purposes of load balancing, in certain embodiments, the controller 120 may include multiple servers. In certain aspects, the controller 120 can receive control input from a user device 142 over the network 130. In certain aspects, the user device 142 can be, for example, a tablet computer, a mobile phone, a mobile computer, a laptop computer, a portable media player, an electronic book (eBook) reader, or any other device having appropriate processor, memory, and communications capabilities.

In certain embodiments, the network 130 can include, for example, any one or more of a personal area network (PAN), a local area network (LAN), a campus area network (CAN), a metropolitan area network (MAN), a wide area network (WAN), a broadband network (BBN), the Internet, and the like. Further, the network 130 can include, but is not limited to, any one or more of the following network topologies, including a bus network, a star network, a ring network, a mesh network, a star-bus network, tree or hierarchical network, and the like.

The controller 120 includes a processor 160, a communications module 162, and a memory 164. The processor 160 of the controller 120 is configured to execute instructions, such as instructions physically coded into the processor 160, instructions received from software in the memory 164, or a combination of both. The communications module 162 is configured to interface with the network 130 to send and receive information, such as data, requests, responses, and commands to other devices on the network 130. The communications module 162 can be, for example, modems or Ethernet cards. The controller 120 may correspond to hardware and/or software that implement mobile device management functions. In certain aspects, the controller 120 also includes an input device 166, such as a keyboard or mouse, and an output device 168, such as a display. In some embodiment, the input device 166 and/or output device 168 may be the user device 142 (as shown in FIG. 2) such that a user may communicate, monitor, and/or manage the indoor growing environment 100 via the user device 142. In some embodiment, the controller 120 includes machine learning software(s) or algorithm(s) stored in the memory 164 to enable the operation of the indoor growing environment 100 under a machine learning mode.

In certain embodiments, the controller 120 monitors and manages the indoor growing environment 100 for efficient nutrient production, such as the production of nitrate, phosphorus, and other nutrients, for indoor organic growing. For example, the controller 120 controls operations of the water room 114 and the irrigation system 124, which is in fluid communication with the nursery 110 and the grow room 112 via various piping selectively distributed throughout the indoor growing environment 100. The water room 114 stores, maintains, and selectively distributes fluids essential to operating the indoor growing environment 100.

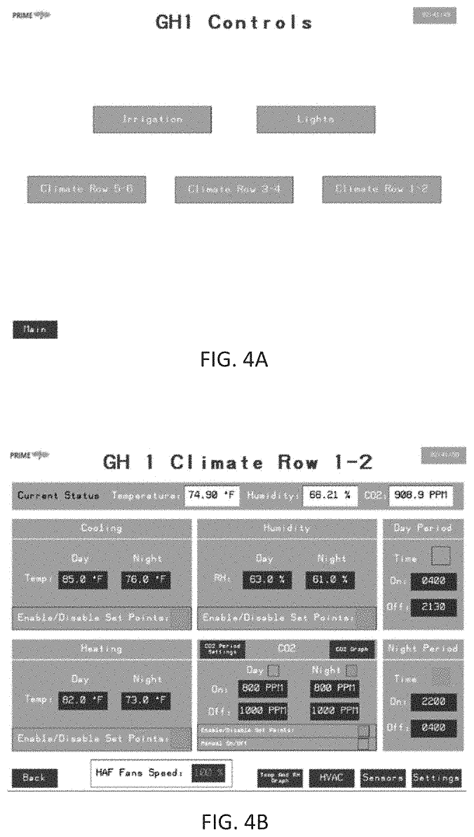

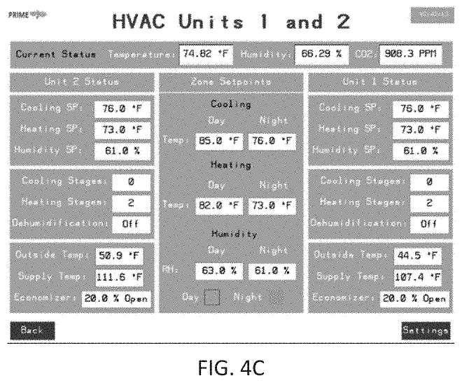

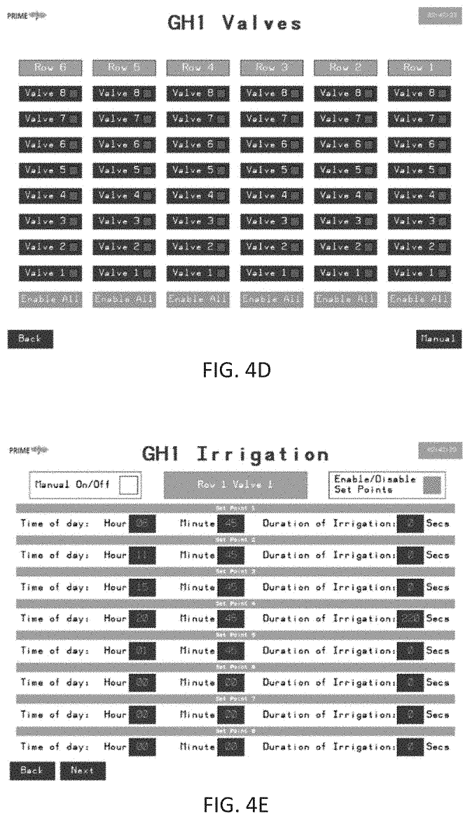

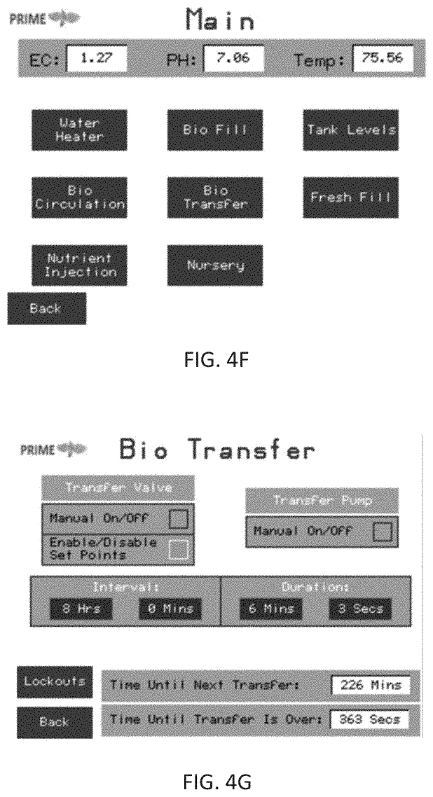

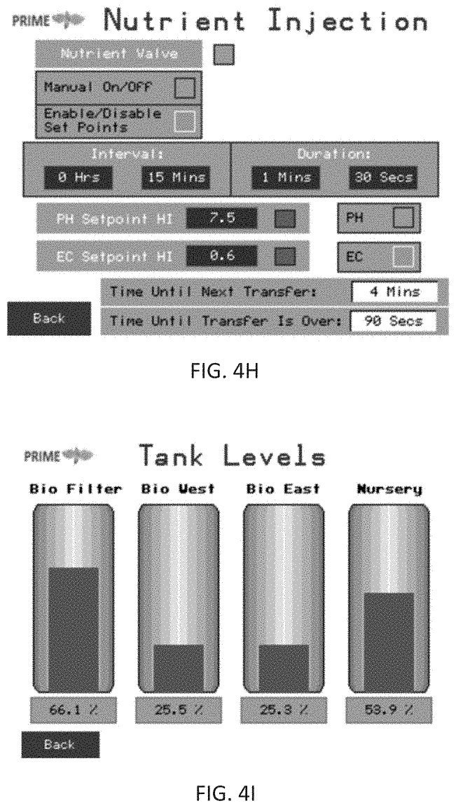

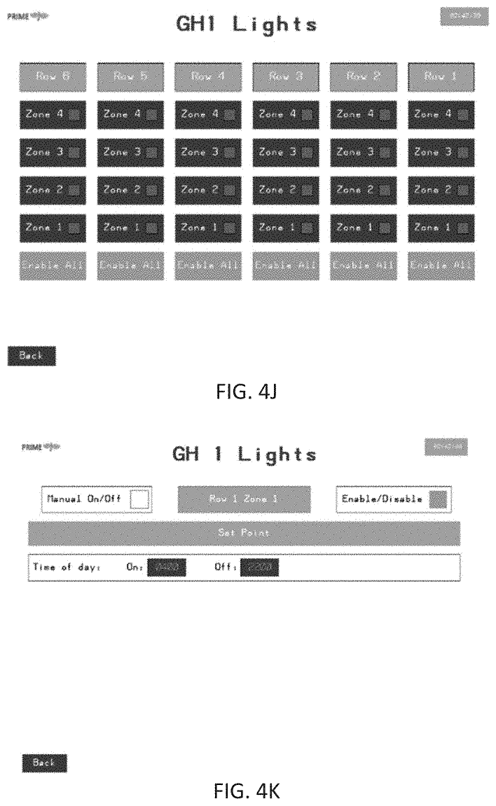

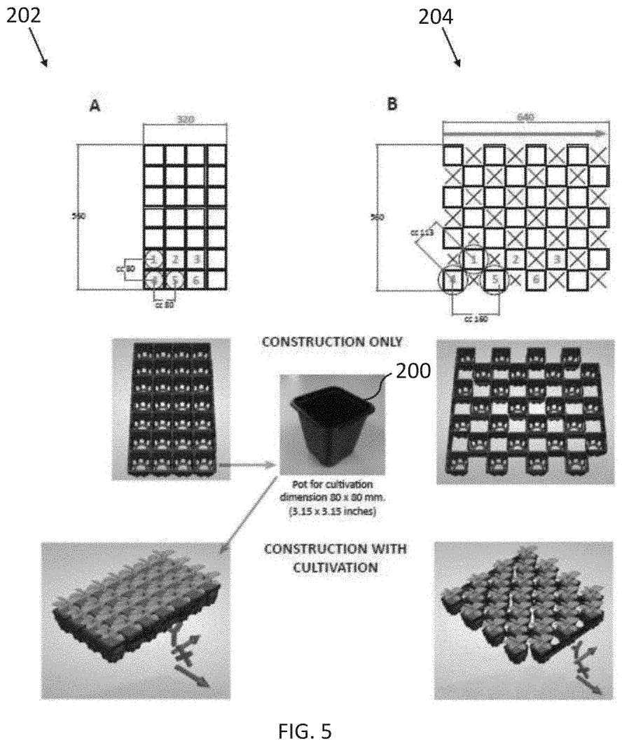

In one embodiment, the controller 120 monitors and manages the nursery 110 and the grow room 112 of an indoor growing environment 100 for maintain efficient indoor organic growing by controlling particular aspects of the climate therein via the air circulation system 122, the irrigation system 124, and the sensor system 126. The controller 120 controls the air circulation system 122, the irrigation system1 124, and the lighting system 128 based on the monitored parameters received from the sensor system 126 associated with growing conditions for each particular plant or herb type, as exemplarily illustrated in FIGS. 4A-4K.

The controller 120 controls the air circulation system 122 based on the monitored parameters received from the sensor system 126 to regulate the climate in the nursery 110 and the grow room 112, as exemplarily illustrated in FIGS. 4B-4C. The sensor system 126 monitors parameters such as, but not limited to, temperature, humidity, wind speed, air flow rate, oxygen content level, carbon dioxide (CO₂) level, direction of air flow on or toward plants, and other well-known parameters in the industry. The controller 120 is in communication with a plurality of HVAC units 121 of the air circulation system 122 located at the indoor growing environment 100. The controller 120 controls the plurality of HVAC units 121 to regulate the heating, cooling, and humidity in different locations of the nursery 110 and the grow room 112 based on monitoring temperature probes from the plurality of sensors 134 strategically disposed across the nursery 110 and the grow room 112. In such a manner, the controller 120 is configured to continuously provide a desired and steady climate in the nursery 110 and the grow room 112 all year round.

The controller 120 communicates with carbon dioxide (CO₂) probes from the plurality of sensors 134 to monitor the CO₂ levels in the nursery 110 and the grow room 112 and controls the air circulation system 122 including a plurality of fans 132 to maintain CO₂ levels at predetermined levels. The controller 120 also controls the plurality of fans 132, based on determining the proper wind speed and/or airflow rate for particular growing requirements within the nursery 110 and the grow room 112. The controller 120 also transmits alarms or notifications when any of the plurality of sensors 134 detects an indication of an undesirable climate or drastic climate change in the nursery 110 or the grow room 112.

In addition to controlling the air circulation system 122, the controller 120 also controls the irrigation system 124 to regulate the climate in the nursery 110 and the grow room 112. For example, the controller 120 controls the plurality of pumps 136 and the plurality of valves 138 of the irrigations system 124 based on the monitored data received from the plurality of sensors 134 of the sensor system 126. In certain embodiments, the controller 120 controls each valve from the plurality of valves 138, which are strategically disposed along the piping distributed across the nursery 110 and the grow room 112, as exemplarily illustrated in FIG. 4E. In certain embodiments, the controller 120 controls up to 130 valves per zone. In certain embodiments, the controller 120 controls the plurality of valves 138 based on predetermined periodic cycles (e.g., 24 hour cycle), as exemplarily illustrated in FIG. 4E. In certain embodiments, the controller 120 receives user input that selectively sets the time of day and duration of irrigation and controls the irrigation system 124 accordingly. Accordingly, the controller 120 monitors the plurality of sensors 134 to identify when to irrigate, how to irrigate (e.g., spray versus mist), specific cycles of irrigation for particular plant type, specific cycles corresponding to growth cycles, and other matters. The controller 120 utilizes the monitored parameters received from the plurality of sensors 134 and controls the air circulation system 122 and the irrigation system 124 based on the particular plant type in the nursery 110 and the grow room 112.

The controller 120 controls a plurality of lights 140 of the lighting system 128, as exemplarily illustrated in FIGS. 4J-4K. The controller 120 monitors sensors (e.g., Photosynthetically Active Radiation or PAR light sensors) from the plurality of sensors 134 associated with the plurality of lights 140 to determine whether the lights are on, off, and functioning properly. When the controller 120 determines that a light from the plurality of lights 140 is not functioning properly it transmits an alert or notification so that proper maintenance will be performed. The controller 120 monitors the plurality of lights 140 to determine the micromole output of the light. Based on the monitored data received from the plurality of sensors 134, the controller 120 determines the growth cycles of the plants or herbs in the nursery 110 and the grow room 112 and transmits notifications on timing of when to seed, plant, or harvest. In certain embodiments, based on such monitored data, the plant or herb may remain in a particular zone or may be transferred, manually or via automation, to a different zone. In certain embodiments, the plant may be transferred on a conveyer belt or by robotic machinery. The transfer of plants or herbs into different zones with the correct climate can efficiently reduce the downtime that is required when resetting the climate in a zone. The climate in a particular zone can instead be constant.

In certain embodiments, the controller 120 receives data from the plurality of sensors 134 indicating the level of moisture inside the soil and controls the irrigation system 124 to maintain the proper level of moisture for the particular plant or herb type. In certain embodiments, a sensor (e.g., a camera or humidity sensor) from the plurality of sensors 134 can detect when a plant canopy has formed or humidity level has risen such that the controller 120 controls the plurality of fans 132 of the air circulation system 122 to adjust air flow between plants to reduce humidity, as described in specific detail below.

The controller 120 monitors and manages the nursery 110 and the grow room 112 for plant management of the indoor growing environment 100 by monitoring each of the different parameters associated with the multiple types of plants being grown therein and controlling the air circulation system 122, the irrigation system 124, the sensor system 126, and the lighting system 128 for each particular type of plant. As discussed above, the nursery 110 can be divided into the plurality of nursery zones 116 so that each nursey zone of the plurality of nursery zones 116 is dedicated to a particular plant type or herb type. Similarly, the grow room 112 can be divided into the plurality of grow zones 118 so that each grow zone of the plurality of grow zones 118 is dedicated to a particular plant type of herb type. Depending on the plant or herb type, each nursery zone and each grow zone will have different growing conditions.

As discussed above, through the communicative and operative coupling between the controller 120 and the various systems/components (shown in FIG. 2) in the indoor growing environment or system 100 can dynamically control and update the operations based on such feedback and control loop.

In another embodiment, the systems are methods are directed to management of the environment in localized and discrete areas (i.e., management of micro environments) such as around a group of plants or a single plant within an indoor plant growing facility (i.e., the macro environment). Although controlled environment agriculture has been practiced to grow plants, it is challenging to maintain a homogeneous and optimal growth environment at a localized level applicable to specific plants. As described above, there are many factors that need to be controlled/maintained to optimize the “macro” environment or climate, and the systems and methods described herein provide for such “macro” control. In addition to maintaining and optimizing the “macro” environment or climate in an indoor facility, there are “micro” or localized environments or climates around each individual plant that are even more challenging to control or maintain. For example, the local temperature, humidity, lighting, airflow, etc. can vary significantly around different portions of a plant, from one plant to another plant, and/or from one location in an indoor growing facility to another.

As one example, relative humidity in indoor plant growing facilities is especially challenging to control. High humidity in a growing environment can stunt plant growth and introduce and increase diseases that affect plants. It is not uncommon for indoor growing facilities where the humidity is controlled at the facility level (i.e., macro level), that localized (i.e. micro level) environment around individual plants can near or even reach 100% relative humidity. Such conditions can significantly limit crop yields and even destroy individual plants.

Plants for commercial growing are commonly positioned in trays that space the plants apart from one another, and the macro environment is controlled to optimize plant growth. However, the mere control of the macro factors (e.g., the lighting, temperature, humidity, airflow, etc. in an indoor plant growing facility) may be ineffective in reducing the humidity at the micro or localized level.

This challenge is especially difficult for certain types of plants, such as for example, plants that develop a significant plant canopy as the plant grows upward and outward. The term “plant canopy” or “canopy” as used herein refers to the above ground growth of a plant's branches, leaves, flowers, etc. that can create a generally continuous or intermittent layer of vegetation covering the stem and roots of the plant. For plants that develop relatively large, laterally spreading canopies above the plant stem and roots, such canopies tend to stifle the circulation of air in and around the area underneath the canopy. In essence, the plant canopy can block some or all of the circulation of air applied to the indoor facility generally for reaching the portions of the plant under the canopy. As a result, it is especially challenging to control the humidity levels around the plant. Different portions of the plant experience different humidity levels, and the area or section underneath the canopy may have a significantly higher humidity level than at the plant top, which can be detrimental to the growth and survival of the plant.

The systems and methods disclosed herein (e.g., the indoor growing environment or system 100) are capable of dynamically controlling the macro as well as micro environments based on a feedback and control loop and machine learning. In particular, the systems and methods disclosed herein can control the micro growth environment dependent on a plant's growth and can effectively improve airflow about that plant's stem, roots, and canopy to adjust the humidity level underneath the canopy to a level beneficial to promote optimal growth for the plant.

Structurally, a tray, plate, or combination thereof is configured to hold and/or support the pots of plants (or plants can be incorporated into the structure) in the grow room 112 or nursery 110. The trays, plates, and combinations thereof disclosed herein are configured to include air flow pathways to permit the flow of air between plants which can be directed upward (or laterally) to flow to the area underneath the plant canopy. The airflow can be channeled through gutters or holes in the tray, which allows for the circulation of air between the plants to control the humidity.

The rate of airflow and when to engage and disengage the airflow system can be specific to small groupings of plants or specific to individual plants and can depend on the humidity levels, temperature, the type of the plant, and/or the extent of the dimensional development of the plant canopy. For example, the humidity or other factors can be monitored and the airflow can be adjusted (e.g., increased or decreased airflow, changed direction or pathway of the airflow, temperature of the airflow) to achieve micromanaging of the local climate that is plant specific. Another factor that can be monitored is the extent to which the canopies of adjoining plants overlap. The airflow can be initiated (or increased) when it is determined that canopies (i.e., the leaves that extend most outward) of two plants are overlapping or touching, or when the outward most tips of the leaves are within certain distant threshold (e.g., 0.1 mm to 10 cm apart). Generally, when the canopy begins to interfere with the generally controlled airflow in the indoor growing facility, the airflow generated from below the plant via the tray, plate, or combinations thereof can be activated to control the airflow on the local or micro level.

The airflow can also be adjusted by adjusting the distance between the plants. The distance between plants can be managed and adjusted throughout the growing process. For example, the distance between plants can be incrementally adjusted and optimized for different stages of the growing process. The relative distance between plants can be expanded (e.g., proportionally by 1.25, 1.5, 1.75, 2, 2.25, 2.5, etc. times the initial distance) after certain time periods after the planting of the plant (or at different growth stages and expanding of the coverage by the plant canopy), and the distant adjustment can be done multiple times throughout the life of the plant. In essence, as the canopy grows, the plants can be spaced apart such that the edges of the canopy are also moved apart to minimize or eliminate the effect of the canopy on the generally controlled airflow in the indoor growing facility.

It is understood that other system components, such as heat lamps, can be added to generate a natural convection of air through the plants to reduce the moisture beneath the plant canopy. This can be created by having heat lamps heat the surrounding air underneath the plants to cause it to rise between the plants (either in the x, y, or z-axes) to reduce the relative humidity under the plant canopy. As the air is warmed and it rises through the moist air that is at a lower temperature, moisture is absorbed and as the air continues to rise, the relative humidity decreases.

The controller 120 can be used in conjunction with the sensor system 126 to manage the environment for indoor plant growing. The controller 120 can be configured to determine whether the plant (e.g., plant canopy) has developed to the extent that airflow between and/or across plants is needed to improve the environment under the canopy and, if so, the rate of the required airflow. For example, sensor from the plurality of sensors 134 (i.e., a camera) can be positioned above the plants and the images generated can be used for (automated) image analysis of the canopy by the controller 120 to determine coverage of the canopy. Once a certain coverage (whether by percentage or by distance to an adjoining canopy) is achieved, the airflow can be initiated and/or the rate of airflow can be adjusted by the controller 120 depending on the canopy coverage.

As another example, a light sensor positioned near or at the bottom of the plant (e.g., near the soil) can be used to determine the amount of light received from above (and what would be received by leaves or portions of the plant underneath the plant canopy). The less light received indicates the more coverage of the canopy because the canopy blocks the light into the lower portions of the plant. Thus, the controller 120 can move the plants apart by mechanical means to provide more access to light.

A humidity sensor can be located both above and below the plant canopy to assess the relative humidity levels experienced by the different portions of the plant to assess whether an optimal growing environment from a humidity standpoint is achieved. A humidity and/or temperature sensors can be used by the controller 120 to directly determine the localized climate and adjust airflow and other environment and climate conditions (e.g., temperature, lighting, distance between the plants, etc.) on a customized basis via a feedback loop to continuously monitor and optimize the localized environment. For example, if a temperature sensor of the sensors 134 determines that the temperature under the canopy of a specific plant is too high, the localized airflow can be increased by the controller 120, which can result in a cooling of the temperature under the canopy of that plant. Once the desired temperature is reached, the airflow can be decrease or stopped to maintain such desirable temperature.

It is appreciated that these monitoring devices (e.g., cameras, sensors, etc. of the sensors 134) can be used with or without the controller 120 as described herein. Multiple controllers can be used in cooperation with one or more sensors. When used with the controller 120, the controller 120 can also be used in a machine learning mode to understand the requirements of specific plants based on the feedback from the monitoring devices and develop an optimal airflow plan and/or algorithm for a specific plant species based on prior growth data.

FIG. 5 illustrates exemplary cultivation pots 200. The pot 200 for cultivation can have any suitable dimensions and sizes. In the illustrated example, the pot 200 is 80 millimeters by 80 millimeters (80 mm×80 mm). It is understood that the cultivation pots 200 can be fixed relative to one another, be movable with respect to one another, be coupled together, or the like, and that the embodiments of the present invention are compatible with any cultivation pot configuration. The pots 200 can be arranged or constructed such that the pots 200 are in line with each other as shown in a line-by-line construction 202 (e.g., cultivation in the spots labeled “1, 2, 3, 4, 5, 6”). For a pot that is 80 mm×80 mm, the center-to-center distance between the directly adjacent pots is 80 mm. The dimension of the line-by-line construction 202 is 560 mm×320 mm.

The pots 200 can also be arranged or constructed such that the construction is extended (e.g., 1, 1.5, 2, 2.5, etc. times its original configuration) horizontally (e.g., in the direction perpendicular to the plant's growth). In the illustrated extended construction 204, plants are cultivated in alternating spots (e.g., cultivation in the spots labeled “1, 2, 3, 4, 5, 6”). The dimension of the extended construction 204 is 560 mm×640 mm, which is doubled the width in comparison to the line-by-line construction 202. Plants have more space to grow in the extended construction 204 since the center-to-center distance between the directly adjacent or first adjacent pots is extended to 113 mm, and the center-to-center distance between the second adjacent pots is 160 mm. The extended construction 204 may allow better air and moisture flow between the pots 200.

The pots 200 in the line-by-line construction 202, the extended construction 204, or any other arrangement or construction can be positioned on a plate or tray. The plate may allow easier and more convenient handling of the pots 200. For example, a large number of plants can be cultivated in the pots 200 resting on the plates that are arranged in repetition in the horizontal direction and/or a vertical direction. The plates holding the cultivated pots 200 can be positioned in a frame or a track. The plate can include ventilation features to allow effective draining of the water, efficient circulation, and ventilation for heat and excess moisture and condensation.

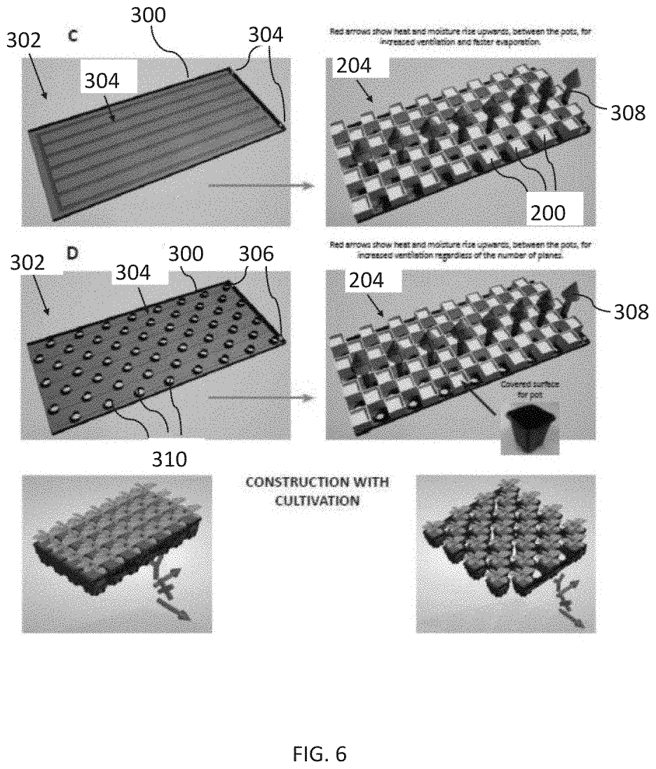

FIG. 6 shows an exemplary plate or tray 300. The plate 300 includes ventilation features 302 including gutters 304 that allow effective draining of water/fluids when emptying and circulation of air underneath and between the pots 300 that are positions on the same plate (i.e., along horizontal directions). The gutters 304 can have any suitable patterns to allow effective draining of water/fluids and air flow circulation. In the illustrated example, the gutters 304 are straight (e.g., substantially parallel to the edges of the plate 300), and the water or fluid is drained at the terminal outlets 306 to exit the plate 300. It is understood that the gutters can run in a non-linear fashion (such as an S-shape or C-shape) and need not extend from one side to another. The gutters may also cross one another to from a crisscross pattern or other type of pattern. The gutters 304 may be distributed in any suitable density. For example, the gutters 304 may have a distribution density such that when the pots 200 are resting on the plate 300, there is a gutter 304 below each pot 200 or each row of pots 200. When the cultivated pots 200 are resting on the plate 300 in the extended construction 204, heat and moisture rise upwards between the pots 200 as indicated by arrows 308. Both the gutters 304 and the extended construction 204 facilitate increased ventilation and faster evaporation.

The size, width, and depth of each gutter can vary, but can range from any dimension that can be formed by extrusion of applicable plastics. In one example, the dimensions can be from 2 mm to 80 mm in depth and from 35 mm to 200 mm in either length or width.

Also as shown in FIG. 6, the ventilation features 302 can also include cavities 310 in any suitable sizes and shapes (e.g., square, circle, ellipse, triangle, etc.) configured to allow efficient ventilation for heat and condensation between planes of the pots 200 (e.g., between the plates 300). For example, the cavities 310 can be cylindrical cavities through the plate 300 (e.g., in the vertical direction). The cavities 310 may be distributed in any suitable density. For example, the cavities 310 may have a distribution density such that when the pots 200 are resting on the plate 300, there is a cavity 310 between each pair of the pots 200. When the cultivated pots 200 are resting on the plate 300 in the extended construction 204, heat and moisture rise upwards between the pots 300 as indicated by arrows 308. The cavities 310 facilitate increased ventilation regardless of the number of planes (e.g., planes are formed when the plates 300 are arranged in repetition in the vertical direction).

The ventilation features 302, including the gutters 304 and/or the cavities 310, contribute to a synergy effect of more efficient circulation, especially when the cultivated pots 200 are arranged in rows and columns of the plates 300 (e.g., several cultivation planes).

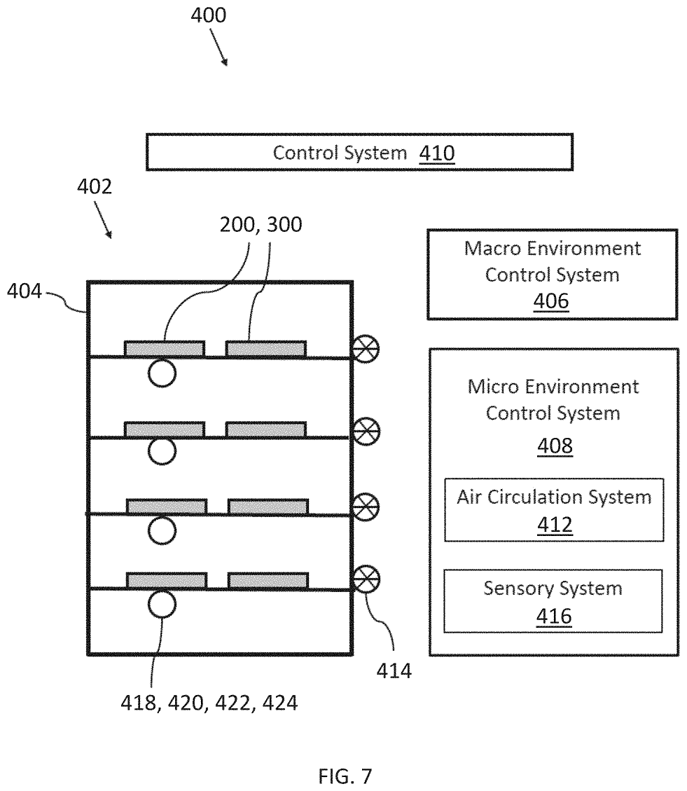

FIG. 7 schematically illustrates an exemplary indoor plant growing facility with an environment management system 400. While the environment management system 400 is illustrated and described herein as a separate system, the environment management system 400 may be the same or used in combination with or incorporated into the indoor growing environment or system 100 (with reference to FIGS. 1-3).

The environment manage system 400 includes systems and/or components as discussed in the indoor growing environment or system 100 with reference to FIGS. 1-3. The plants are cultivated in a cultivation zone 402 (e.g., the nursery zone 116 and/or the grow zone 118). The cultivated pots 200 are resting on trays (the plates 300 as shown in FIG. 6). A frame 404 with a plurality of horizontal and vertical frame members is configured to support the cultivation pots 200 (in the trays). There may be one or more frames 404 in the cultivation zone 402.

The environment management system 400 includes a macro environment control system 406 and a micro environment control system 408 configured to monitor and control the macro and micro environments/climates in the indoor plant growing facility (e.g., the indoor growing environment 100), respectively. While the macro environment control system 406 and micro environment control system 408 are illustrated and described herein as separate components, the macro environment control system 406 and micro environment control system 408 may be incorporated into the controller 120 (with reference to FIGS. 1-3). The environmental management system 400 also includes a control system 410 communicatively and/or operatively coupled to the various systems and components of the environment management system 400. Similarly, the control system 410 may be or can be incorporated into the controller 120 (with reference to FIGS. 1-3).

The macro environment control system 406 may include all environment/climate control systems in a typical green house or an indoor plant growing facility to control the macro environment (e.g., systems and components in FIGS. 1-3). For example, the macro environment control system 406 can include a HVAC system (e.g., the air circulation system 122), a humidifier/dehumidifier, water/liquid circulation system (e.g., the water room 114, the irrigation system 124), a lighting system (e.g., the lighting system 128), a sensor system (e.g., the sensor system 126), etc. to condition the macro environment or climate for optimized growth results.

The micro environment control system 408 includes systems and equipment to control or condition the micro or localized environment. The micro environment control system 408 may be a separate unit or may be a sub-unit of the macro environment control system 406.

The micro environment control system 408 may monitor and control micro environment conditions, which may include temperature condition, humidity condition, airflow condition, lighting condition, etc. These micro environment conditions may be controlled and optimized with specificities for one cultivated pot 200, several cultivated pots 200, a plate 300 of cultivated pots 200, several plates 300 of the cultivated pots 200, a frame 404 of the cultivated pots 200, several frames 404 of the cultivated pots 200, or a section (e.g., an upper section, a lower section, a middle section, a left or right section) of the cultivation zone 402.

The micro environment control system 408 can include an air circulation system 412 to control the localized air circulation. For example, the air circulation system 412 includes fans 414 (e.g., the fans 132) to provide airflow between the plants (e.g., between the cultivated pots 200). The fans 414 can be removably coupled to the plates 300 or the frame 404 or can be disposed adjacent or in proximity to the plates 300 or the frame 404. The density, location, and orientation of the fans 414 are adjustable to optimize the air circulation to the cultivated pots 200.

The air circulation system 412 can control and adjust (increase or decrease) the airflow conditions coming out the fans 414. For example, the air circulation system 412 can control and adjust the rate, volume, temperature, humidity, and/or direction of the airflow from the fans 414. For example, if the control system 410 determines that the temperature localized to a specific set of cultivation pots is too high, the rate of the associated fan 414 can be increased to lower the localized temperature. If the control system 410 determines that the temperature localized to a specific set of cultivation pots is too low, the rate of the associated fan 414 can be decreased so that the localized temperature rises.

It will be appreciated that the combination of the ventilation features 302 and the localized air circulation system 412 can have synergistic effects on removing the excess moisture and controlling the localized humidity levels.

The micro environment control system 408 can include a sensory system 416 (e.g., the sensor system 126) to monitor the micro environment conditions at the cultivation pots 200. For example, the sensory system 416 can include camera(s) 418, light sensor(s) 420, presence or motion sensor(s) 422, and climate sensor(s) 424.

The camera 418 can be disposed in proximity to the cultivated pots 200 to monitor the growth of the plants. For example, the camera 418 can be used for image analysis of the plant to determine whether the canopy has grown, distances between tips of the leaves/canopy of the adjacent plants, the coverage of the canopy, the type of plant, etc.

The light sensor 420 can be disposed in proximity to the cultivated pots 200 to determine the coverage of the canopy. In one example, the light sensor 420 is disposed underneath where would be the location for the canopy (e.g., in the cultivation pot 200 or on the plate 300) to determine the amount of light being received at the bottom of the plant (e.g., the portion underneath the canopy, near the soil). The less the received light indicates the more coverage of the canopy since the canopy blocks the light. The light sensor 420 can also be used to determine the distances between the leaves/canopy of the adjacent plants.

The presence or motion sensor 422 can be used to determine the presence of the canopy, the coverage of the canopy, and/or the distances between the tips of the canopy/leaves of the adjacent plants.

The climate sensors 424 can include a temperature sensor and/or a humidity sensor. The climate sensors 424 are disposed in proximity to the cultivation pots 200 to determine the micro or the localized climate conditions. In one example, the climate sensor 424 is disposed underneath the canopy to determine the humidity level and/or temperature underneath the canopy.

The distribution densities of the sensors 418, 420, 422, and/or 424 are optimized to provide sufficient information useful in determining the growth conditions and/or the localized growth environment/climate. For example, the distribution density can be one sensor per pot, one sensor per several pots, on sensor per plate, or one sensor per section of the frame, or one sensor per frame, etc.

The control system 410 is configured to operate and coordinate the operation of the environment management system 400. In particular, the control system 410 is communicatively and/or operatively coupled to the micro environment control system 408, the macro environment control system 406, or both. The control system 410 can be a computer or can include any suitable processer(s), microprocessor(s), transceiver(s), memory, a timer, analog-to-digital convertor(s) (ADC), programmable logic controller(s) (PLC), human machine interface(s) (HMI), etc. to enable its functions. The control system 410 can include any suitable user interface and/or display to allow output (e.g., the output device 168, the user device 142) of the monitored information and/or analysis results and allow a user to program or control the operation of the environment management system 400. The control system 410 can perform environment management tasks following pre-programmed procedures and/or can perform dynamic analyses to update operations in-situ. In particular, the control system 410 can include a growth analysis module to determine the development of the plant and update the operation of the environment management system 400 dependent on the type of the plant and/or the development of the plant. The control system 410 can be the same or incorporated in the control system shown in FIG. 2.

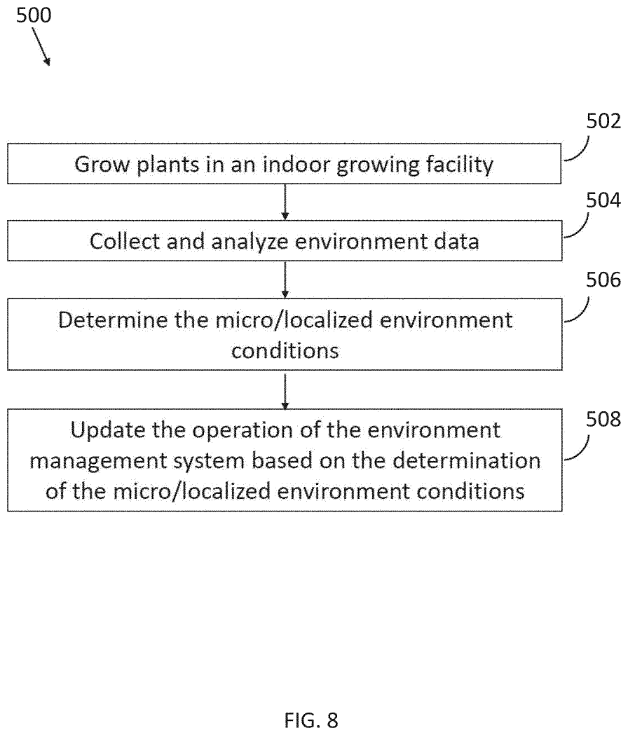

FIG. 8 is a flowchart of a method 500 for growing plants using the environment management system 400. The steps discussed herein are controlled and executed by the control system 410. The method 500 includes growing plants in an indoor growing facility (step 502). At step 502, the cultivations pots 200 are placed on plates/trays which are loaded to the frames 404 in the cultivation zone 402 (see FIG. 7). The line-by-line construction 202 and/or the extended construction 204 can be used for planting. Conventional trays and/or trays with ventilation features 302 as in the plate 300 can be used for supporting the cultivation pots 200. The macro environment control system 406 is activated to maintain/optimize the macro environment/climate in the indoor growing facility.

The method 500 includes collecting and analyzing environment data (step 504). The environment data can include any data related to the macro environment and/or the micro environment in the indoor growing facility. For example, the environment data includes temperature, lighting, humidity, growth or development of the plants, the types of the plants, the constructions (the line-by-line construction 202, the extended construction 204) of the cultivation pots 200, etc. At step 504, the control system 410 collects and analyzes environment data from the sensory system 416 configured to monitor the micro environment conditions. In some embodiments, the control system 410 can also collect and analyze macro environment data from the macro environment control system 406 (e.g., temperature, humidity, lighting, etc. in the indoor growing facility) at step 504.

The method 500 includes determining the micro/localized environment conditions (step 506). At step 506, the control system 410 determines the micro/localized environment conditions based on the data collected/analyzed in step 504. As one example, the control system 410 is configured to determine the development of the plant based on data from the sensory system 416. The development of the plant can be evaluated based on the presence of canopy (e.g., whether the plant leaves or canopy have grown), the coverage (%) of the canopy, the distances between the tips of the leaves/canopy of the adjacent plants, the size of the plant canopy, etc. As another example, the control system 410 is configured to determine the humidity and/or temperature at the bottom of the plant (e.g., the portion underneath the canopy, near the soil). As another example, the control system 410 is configured to determine the amount of light received at the bottom of the plant (e.g., underneath the canopy, near the soil).

The method 500 includes updating the operation of the environment management system 400 based on the determination of the micro/localized environment conditions (step 508). The control system 410 is configured to continuously monitor and optimize the micro/localized environment based on the determination made in step 506 via a feedback and control loop.

The control system 410 is configured to adjust the operation parameters of the air circulation system 412 in response to determining that a predetermined canopy coverage threshold has been achieved. The adjustable operation parameters of the air circulation system 412 can include activation/deactivation, airflow rate and/or volume, flow direction, temperature, and humidity of the airflow, etc. The predetermined canopy coverage threshold can by 100%, 90%, 80%, 70%, 60%, 50%, 40%, 30%, 20%, 10%, 5%, or 1% (e.g., at the initial presence/growth of the canopy).

Generally, once a plant canopy grows to the point where the plant's stem and roots are covered by the canopy, regardless of specific plant, relative humidity will rise. Such rise in relative humidity can approach or even reach the point of saturation (i.e., 100% relative humidity). At such levels, the leaf stomata (i.e., the small pores on the surface of a leaf) will close, and the growth of the plant will be severely limited or even stopped. In addition, under such conditions, water can condense and pool on surfaces, which can initiate and promote growth of diseases, especially fungi, on and around the plant. Such diseases can harm or even kill the plant. The systems and methods disclosed herein can manage the climate local to a plant so as to avoid a dew point at any given temperature, which in practice results in the relative humidity not exceeding 85% within the canopy, which, for any given plant, maintains effective growth and high yields.

The predetermined canopy coverage thresholds can be different or the same for different operation parameters of the air circulation system 412. In one example, the control system 410 is configured to turn on or activate the air circulation system 412, or to increase the airflow rate and/or volume of the air circulation system 412 in response to determining that the canopy has grown. In another example, the control system 410 is configured to turn on or activate the air circulation system 412 or to increase the airflow rate and/or volume of the air circulation system 412 in response to determining that a predetermined micro/localized humidity threshold has been achieved. In another example, the control system 410 is configured to turn on or activate the air circulation system 412 or to increase the airflow rate and/or volume of the air circulation system 412 in response to determining that a predetermined micro/localized temperature threshold has been achieved. In another example, the control system 410 is configured to adjust, increase, or decrease at least one of the micro/localized environment conditions (underneath the canopy) in response to determining that at least one of the predetermined micro/localized thresholds has been achieved. The micro/localized environment conditions and the predetermined thresholds are humidity, temperature, airflow rate, airflow volume, airflow direction, lighting (intensity and coverage), and the development/growth of the plant (e.g., canopy coverage %), etc.

The control system 410 can also be configured to adjust operation of the macro environment control system 406 based on the determination of the micro/localized environment conditions. For example, the control system 410 can adjust (e.g., increase or decrease) the macro temperature, humidity, lighting, etc. in response to determining that a predetermined micro/localized temperature threshold, humidity threshold, or canopy coverage threshold has been achieved.

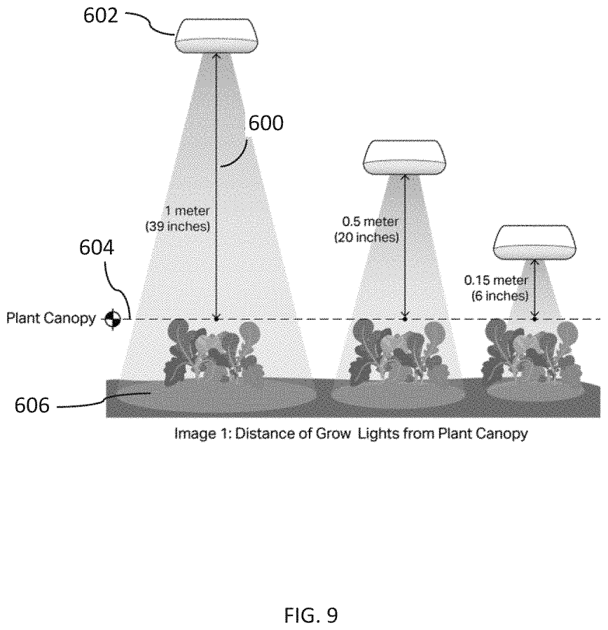

In one example, the control system 410 is configured to adjust the lighting in response to determining that a predetermined canopy coverage threshold has been achieved. Adjustments of the lighting can include adjusting of the light intensity, the light incident angle, the distance, the type of light, etc. FIG. 9 shows exemplary adjustments of the distance between grow lights and plant canopy. The distance 600 for the lighting is defined as the vertical distance between the light 602 and the top of the plant canopy 604. The greater the distance 600, the greater the corresponding light coverage area 606, which can also correspond to a lower light intensity at the bottom of the plant (e.g., underneath the canopy, near the soil). The distance 600 can be adjusted to any suitable distances, e.g., 1 meter, 0.5 meter, or 0.15 meter.

The control system 410 can also be configured to output operational suggestions based on the determination of the micro/localized environment conditions. In one example, the control system 410 can be configured to output or display any of the above mentioned operational adjustments to the micro environment control system and/or the macro environment control system to a user. The user may review the suggestions and make a determination to accept or decline the operational suggestions. The control system 410 then updates the operation of the environment management system based upon the user's decision.

In another example, the control system 410 can be configured to re-arrange the pot construction (the line-by-line construction 202 or the extended construction 204) or output/display suggestions for re-arranging the pot construction in response to determining that a predetermined canopy coverage threshold or a predetermined micro/localized humidity, lighting, or temperature has been achieved. The pot construction rearrangement can be automated such that the pot handling system moves the pots relative to one another to reduce the coverage generated by the plant canopy, which would allow for more air to flow between the plants. The environment management system 400 can include an automated pot handling apparatus or system configured to re-arrange the pots 200 and/or the plates 300. As such, the pot construction may be updated throughout the life cycle of the plants to optimize the grow space for better air circulation/ventilation. In some embodiments, the automated pot handling apparatus or system can move the pots 200 from the nursery 110 to the grow room 112, or vise versa, based on a determination of the optimized grow condition.

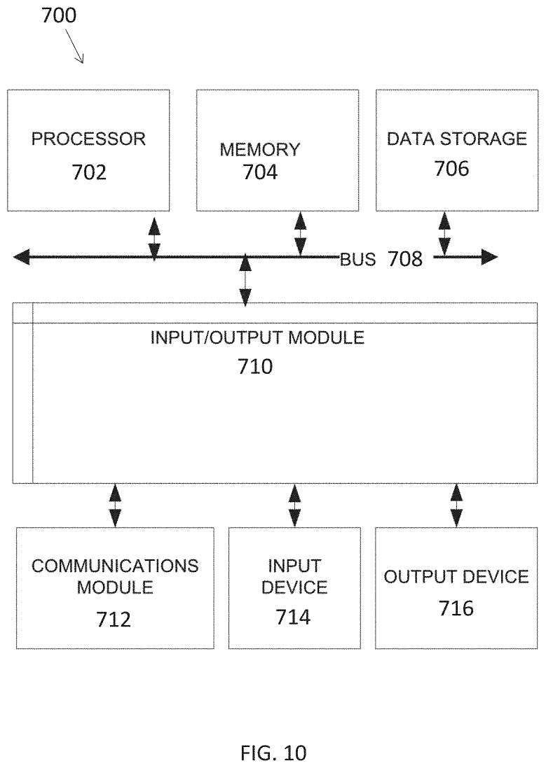

FIG. 10 is a block diagram illustrating an example computer system 700 with which the controller 120 and the user device 140 of FIG. 2 and the input device 166 and the output device 168 of FIG. 3 can be implemented. In certain aspects, the computer system 700 may be implemented using hardware or a combination of software and hardware, either in a dedicated server, or integrated into another entity, or distributed across multiple entities.

Computer system 700 (e.g., the controller 120 and the user device 142) includes a bus 708 or other communication mechanism for communicating information, and a processor 702 (e.g., the processor 160) coupled with bus 708 for processing information. According to one aspect, the computer system 700 can be a cloud computing server of an infrastructure as a service (IaaS) that is able to support PaaS and SaaS services. According to one aspect, the computer system 700 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the computer system 700 may be implemented with one or more processor 702. Processor 702 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., the memory 164), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, e.g., one or more modules of computer program instructions encoded on a computer readable medium for execution by, or to control the operation of, the computer system 700.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Example input/output modules 710 include data ports such as USB ports. In addition, input/output module 710 may be provided in communication with processor 702, so as to enable near area communication of computer system 700 with other devices. The input/output module 710 may provide, for example, for wired communication in some implementations, or for wireless communication in other implementations, and multiple interfaces may also be used. The input/output module 710 is configured to connect to a communications module 712. Example communications modules 712 (e.g., the communications module 162) include networking interface cards, such as Ethernet cards and modems.

In certain aspects, the input/output module 710 is configured to connect to a plurality of devices, such as an input device 714 (e.g., the input device 166) and/or an output device 716 (e.g., the output device 168). Example input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device.

According to one aspect of the present disclosure the controller 120 and the user device 142 can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in main memory 704 causes processor 702 to perform the process steps described herein. One or more processors in a multi-processing arrangement may also be employed to execute the sequences of instructions contained in memory 704. Processor 702 may process the executable instructions and/or data structures by remotely accessing the computer program product, for example by downloading the executable instructions and/or data structures from a remote server through communications module 712 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

As further disclosed herein are methods and systems for creating, monitoring, and maintaining a steady state system that can generate nitrate that result in a complete, productive, and sustainable organic growing environment in which to grow plants such as vegetables and herbs at an industrial scale. Organic agriculture has become increasingly popular over the last few decades. Much of the demand for organic agriculture is driven by consumers' desire for their families to have a healthy and sustainable diet. In addition, recent and anticipated government regulations are encouraging the agricultural industry to increasingly invest in organic agriculture. In essence, organic agriculture attempts to mimic and reproduce growing methods that occur in nature. Organic agriculture strives to apply lessons learned from nature to enhance the fertility and biodiversity of soil in a sustainable manner without the use of synthetically produced chemicals such as pesticides, fertilizers, antibiotics, and the like. The purpose of applying and enhancing growing processes found in nature is that harnessing and enhancing nature's processes can increase yields, extend the growing season, and facilitate indoor, year-round growing of agricultural products.

While the goal of organic agriculture is to reproduce naturally occurring processes, the agricultural industry has found it very challenging to do so. This is particularly true when applying soil fertilization and enhancement processes at an industrial scale. In one example, large scale agricultural enterprises have found it particularly challenging to reproduce nature's “nitrogen cycle,” where atmospheric nitrogen is harvested from the surrounding air and converted to nitrate embedded in the soil, which are useful in the growing of plants. FIG. 11 illustrates such a nitrogen cycle. Atmospheric nitrogen (N₂) composes the majority of the earth's atmosphere; however, it is not particularly useful to living organisms in its atmospheric state. When such atmospheric nitrogen is absorbed into soil, it encounters naturally occurring bacteria and undergoes a synergistic and alternative processes commonly referred to as “fixing,” “ammonification,” and “nitrification.” Such processes convert atmospheric nitrogen (N₂) to nitrite (NO₂), where such nitrite are subsequently converted to nitrate (NO₃). Nitrate are a key nutrient needed for plants to form proteins, such as amino acids and nucleotides, in plant tissue. Fixing refers to the conversion of nitrogen to ammonia (NH₃). Such a conversion occurs when certain bacteria living in the soil (where such bacteria has a nitrogenase enzyme) combine gaseous nitrogen with hydrogen to produce ammonia. Nitrification is the conversion of ammonia (NH₃) or ammonium (NH₄⁺) to useful nitrate (NO₃⁻). Such a conversion can be performed by bacteria living in the soil such as Nitrosomonas and Nitrobacter. Ammonification is an alternative process where bacteria or fungi converts nitrogen from decomposing organic material into ammonium (NH₄⁺). The ammonium subsequently undergoes a nitrification process and is converted to nitrate (NO₃⁻). Once converted into nitrate, the nitrate can be absorbed through the roots of a plant and assimilated into plant tissue as protein. It has also proved difficult for the agricultural industry to successfully create and maintain effective levels of phosphorus to mimic those found in nature. Phosphorus is important to plant growth and facilitates a number of functions such as energy transfer, photosynthesis, transformation of sugars and starches, nutrient mobility within the plant, and transfer of genetic characteristics from one generation to the next.

There is a need in the agricultural industry for novel systems and processes for forming organic substances, such as nitrate and phosphorus, and delivering such organic substances to a growing environment to enhancing the fertility and biodiversity of soil used to grow plants in a sustainable manner to support organic agriculture on an industrial scale. Disclosed herein are such novel systems and processes for managing nitrate-forming bacteria to enable the production of nitrate and subsequently the forming of nutrient rich fluids useful in organic agriculture. Such nutrient rich fluids can be used to enhance the characteristics of soil used in organic agriculture, where such nutrient rich fluids can be liquids or slurries that are rich in organic nutrients, such as nitrogen and phosphorus, and delivered to the growing environment to irrigate and enrich the soil.

The systems and processes described herein: facilitate the formatting and maintenance of soil health for growing plants, create biodiversity in the soil, are sustainable, refrain from using synthetic chemicals, maintain a healthy growing environment, and are applicable to organic agriculture conducted on an industrial scale. The systems and methods described herein form soil that is rich in nutrients and has a solid structure in which plant roots can efficiently absorb and assimilate such nutrients. The soil includes bacteria and fungi that create a balance between water and soil and prevent pest development. The systems and methods provide sustainability through recycling of water, minimizing carbon dioxide output, using green waste as fertilizer, and providing a nutrient-rich irrigation fluid.

A system, as will be further described herein, is arranged to form nutrient-rich irrigation fluids for use on soil suitable for efficiently growing plants on an industrial scale, including indoor growing of plants on an industrial level. Table 1 below generally lists elements and concentrations in soil that are sufficient for growing plants.

TABLE 1

| | Chemical | | | Relative number |
|---|---|---|---|---|
| Element | Symbol | mg/kg | Percentage | of atoms |
| Nitrogen | N | 15,000 | 1.5 | 1,000,000 |
| Potassium | K | 10,000 | 1.0 | 250,000 |
| Calcium | Ca | 5,000 | 0.5 | 125,000 |
| Magnesium | Mg | 2,000 | 0.2 | 80,000 |
| Phosphorous | P | 2,000 | 0.2 | 60,000 |
| Sulfur | S | 1,000 | 0.1 | 30,000 |
| Chlorine | Cl | 100 | — | 3,000 |
| Iron | Fe | 100 | — | 2,000 |
| Boron | B | 20 | — | 2,000 |
| Manganese | Mn | 50 | — | 1,000 |
| Zinc | Zn | 20 | — | 300 |
| Copper | Cu | 6 | — | 100 |
| Molybdenum | Mo | 0.1 | — | 1 |
| Nickel | Ni | 0.1 | — | 1 |

The process for forming nutrient-rich soil begins with mixing a number of components together to form a “living” substrate. Such components include: peat (partially decomposed organic matter), coir (fibrous materials from, for example, husks of coconuts), lime (calcium carbonate CaCO₃), bacteria (formed from aerobically composted materials such as, for example, turkey litter), bone meal (ground animal bones), and water. The mixture is arranged such that the pH range is between approximately 5 and 7.5. This mixture provides a sufficient amount of most of the elements listed in Table 1. However, it is particularly challenging to reproduce the nitrogen and phosphorous level found in soil in natural growing environments. In addition, iron can oxidize in the presence of water, making it difficult for plants to absorb. Thus, the systems and methods disclosed herein provide techniques that manage the nitrate-forming bacteria for providing sufficient levels of absorbable nitrogen, phosphorus, and iron, thus, providing nutrient-rich soil beneficial to the growing of plants.

With regard to iron (Fe), methods will be implemented to chelate iron atoms to maintain its stability. While iron is soluble as a ferrous ion (Fe²⁺), the ferrous ion typically oxidizes in the presence of water to form a ferric ion (Fe³⁺), which cannot readily be absorbed by a plant. Thus, the mixture described above includes a chelating agent to bond with the iron atoms and form a molecule that is readily absorbable by a plant. One such chelating agent is an amino acid, which forms an absorbable iron amino acid complex. With regard to phosphorus, it is highly reactive and is not typically found as a free element in nature. However, the mixture described above provides phosphorus that can be absorbed by plants through interaction of the bone meal and beneficial bacteria.

With regard to nitrogen, the systems and methods described herein will focus on management of a process of using bacteria and fungi, referred to as decomposers, to break down organic materials in the form of dead organisms, plants, and animals in the soil, progressing from protein to amino acids to ammonium. Nitrification will then further break down the ammonium into nitrate (NO₃), which are very useful for growing plants. The process of converting nitrogen to nitrate requires two steps, performed by two different types of bacteria. In one example, the systems and methods described herein will use Nitrosomonas to convert nitrogen and ammonia to nitrite (NO₂), then Nitrobacter will interact with the nitrogen dioxide to add a third oxygen atom to create nitrate (NO₃). Plants consume the nitrate in the soil and use the nitrate to form nucleotides, amino acids and other vital proteins that are stored in the plant tissue. Nitrosomonas and Nitrobacter are commonly referred to as “chemotrophs.” Chemotrophs metabolize nitrogen along with oxygen and multiply slowly, thus the handling of such chemotrophs is important to the processes described herein. The systems and methods disclosed herein manage the bacteria to optimize the nitrification process to achieve a maximum yield of nitrate.

The system and methods described herein manage and account for a number of considerations in providing nitrate for consumption by plants. Such considerations include: decomposers multiply at a very rapid rate and need to be controlled or decomposers may pollute the soil; nitrifying bacteria requires nitrogen in an environment free from decomposing bacteria and fungi; nitrifying bacteria requires sufficient oxygen levels; the amount of ammonia and/or ammonium transfer into nitrate should be measurable and controllable; and nitrification can take place both in soil and water.

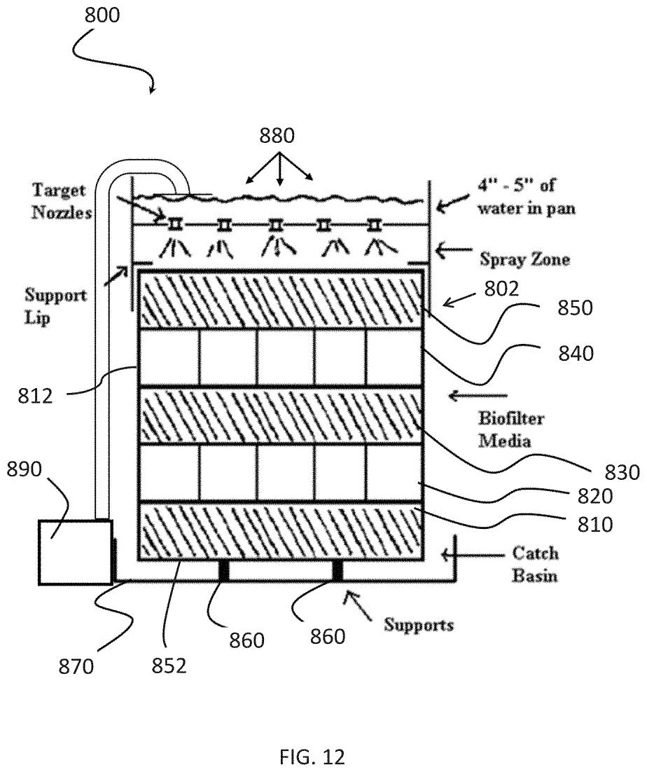

An exemplary nitrate forming and delivery system 800 (e.g., including a biofilter or soil enrichment system) is illustrated in FIG. 12. Such a system generates nitrate for delivery to a growing environment to enrich soil with nitrate. The nitrate forming and delivery system 800 includes a number of layers (e.g., biofilters 115 in FIG. 1) including a first biofilter media layer 810, a first support layer 820, a second biofilter media layer 830, a second support layer 840, and a third biofilter media layer 850. The biofilter media layers are disposed within exterior walls 812. The layers are supported by a pair of base supports 860, and a catch basin 870 is positioned below the layers. A series of nozzles 880 are positioned above the layers and fed by a pump 890 positioned proximate to the catch basin 870. The nitrate forming and delivery system 800 can be supported by a number of shelves or a shelving system 802 to hold the biofilter media layer (810, 830, 850) so that the biofilter media can be pulled out from time to time for periodic cleaning of seeding of a separate nitrate forming and delivery system. Oxygen levels within the biofilter media should be maintained properly, or the production of nitrate can be reduced.

The biofilter media layers (810, 830, 850) include biofilter media constructed with a honeycombed-shaped structures, which provide a substantial amount of surface area for the growth of bacteria. Such a honeycomb structure can be constructed from a plastic material well suited for bacterial growth. The honeycomb arrangement is an exemplary arrangement, but it is understood that the structure upon which the bacterial will grow can be sufficiently porous to permit the circulation of oxygen between and around the medial layers. The structure of the biofilter media can be any structure that provides for a substantial surface area for bacterial growth. For example, the biofilter media can be a series of slates, a collection of rings, semi-spheres, or any other structure that offers a substantial surface area as compared to the overall spatial volume that it occupies.

Once introduced, bacteria useful in the nitrification process will adhere to and multiply on the surface area of the biofilter media forming a bacteria colony. The biofilter media include multiple surfaces, each suitable for colonization by multiple colonies of nitrifying microorganisms (e.g., nitrifying bacteria), and each surface is accessible independent of other surfaces through the shelving system 802. A stream of water and nitrogen rich material, also referred to as a feed, is continuously pumped through the series of nozzles 880, which sprays water in a targeted manner over the biofilter media layers (810, 830, 850) to provide for oxygen saturation. The feed is drained from one or more drains 852 that allow the feed to drain from the biofilter media layers (810, 830, 850) to the catch basin 870. The pump 890 retrieves the feed from the catch basin 870 and moves the feed to the top of the nitrate forming and delivery system 800 to the series of nozzles 880, which spread the feed equally over the top surface of the nitrate forming and delivery system 800. As the feed moves downward through the nitrate forming and delivery system 800, it passes through the biofilter media, picking up nitrate. The feed continues downward, due to gravity, through the nitrate forming and delivery system 800 and again flows to the catch basin 870. The feed is continuously recycled through the nitrate forming and delivery system 800 providing for sustainability with regard to water usage. This recycling process continues until there is sufficient nitrate in the water to make it a nutrient rich fluid, which is then moved either to a holding tank (e.g., coupled to the catch basin 870) or pumped to the growing area (e.g., the nursery zones 116 and the grow zones 118) for fertilizing crops. Through the recycling process, the liquid collected at the catch basin 870 eventually becomes a nitrate enriched fluid.

The nitrate forming and delivery system 800 may be a part of or used in combination with the water room 114 and the irrigation system 124. The water room 114 as illustrated includes a novel system and method for preparing and enhancing the characteristics of soil useful in organic agriculture. Such enhancement of soil characteristics is achieved by forming liquids and slurries that are rich in organic nutrients, such as nitrogen and phosphorus, and delivering such liquids and slurries to irrigate the soil.

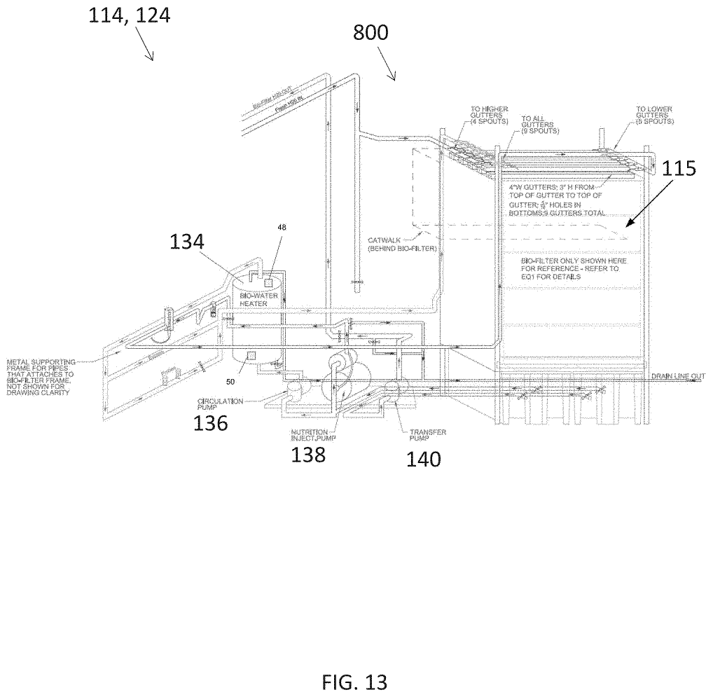

For example, with reference to FIG. 13, the nitrate forming and delivering system 800 includes the biofilter assembly 115, a bio-water heater tank 134, a circulation pump 136, a nutrition injection pump 138, a transfer pump 140, and other components for distributing fluids to the nursery 110 and grow room 112. As illustrated in FIG. 13, the nitrate forming and delivering system 800 is constructed on an industrial scale.

Prior to an introduction of the feed to the nitrate forming and delivering system 800, an equilibrium is reached regarding the flow of the water and oxygen saturation. Once such an equilibrium is reached, nitrogen in the form of ammonium (NH₄⁺) or ammonia (NH₃) is introduced into the stream of water to form the feed. As the nitrate forming and delivering system 800 matures, the nitrifying bacteria will continue to grow and colonize on the surfaces of the filter cells. As discussed further below, the attainment and maintenance of system equilibrium prior to the introduction of nitrogen is performed by a series of sensors (e.g., the sensor system 126) and a programmable logic controller (e.g., the controller 120) that allow for the real-time adjustment of the system parameters.

Typically, in approximately six to eight weeks, the biofilter media will be fully colonized and in balance, and the colony will reach maximum production levels. A factor that influences the yield of the colony is the temperature of the environment, where the optimum temperature for maximizing bacteria multiplication rate is approximately 27° C., which is measured by a temperature probe. While 27° C. may be an optimum temperature, the bacteria adapts well to changing circumstances when temperature is adjusted relatively gradually over time. Generally, the system can operate in the temperature range of 20° C. to 28° C. The amount of bacteria should be closely maintained and is measured and managed as discussed below. An insufficient amount of bacteria in the system would result in excessive levels of ammonia and/or ammonium, which can result in excess levels of NO₂⁻, which can block the transformation to NO₃⁻ and harm the efficiency and output of the system.

Once a first system has reached its maximum capacity of nitrate production, a second system can be started by using biofilter media from the first system. Such biofilter media can be removed from the first system and placed into a second system. Under such circumstances, the second system can be at maximum capacity in about two to three weeks, and the first system also quickly returns to maximum capacity. Such a seeding process can allow an operation to expand quickly. Thus provided are methods of producing biofilters.

One object of an embodiment of a system and method is for real-time monitoring of the system performance to ensure that it is performing under acceptable conditions (i.e., equilibrium or homeostasis) and active adjustment of the parameters in the event the performance conditions are not acceptable. This requires an evaluation of the above-referenced system parameters to assess the system's performance and make adjustments, if necessary, to achieve a targeted performance level. A multitude of parameters may be measured to achieve this objective. For example, in some embodiments, as the feed repeatedly passes through the system and is applied to the biofilter media, the system can continuously or periodically monitor certain parameters of the feed as it gains nutrients, where examples of such parameters include levels of ammonium (NH₄⁺, or alternatively ammonia (NH₃)), nitrite (NO₂⁻), and nitrate (NO₃⁻), electrical conductivity (E_{c}), pH level, O₂ level, an ammonium/nitrite ratio or any combination thereof. Similarly, once the feed is moved to a holding tank, such parameters of the feed can be measured and monitored.

In one example, the ammonium/nitrite ratio range that achieves a desired output of nitrate from the biofilter media is a ratio of between 0 to about 40. The system can be controlled to establish and maintain such a ratio. In one example, the composition of the feed (i.e., the relative amount of ammonium and water) is controlled such that the ammonium/nitrite ratio is approximately 4, where the level of ammonium is approximately 40 ppm and the nitrite level is approximately 10 ppm. If the ratio rises above 4, the introduction of ammonium into the feed can be slowed or stopped for a period of time so that existing ammonium can be converted nitrite, raising the levels of nitrite, and lowering the levels of nitrite, and the desired ratio can be restored. If the ratio falls below 4, more ammonium is added to the feed to reestablish the desired ratio.

In other examples, during nitrate production, the O₂ level of the system can range from 5 parts per million (ppm) to 15 ppm, and the pH of the feed can range from 6.0-6.5 or 5-5.5. The pH level of the nutrient rich fluid produced by the system can range from 4.5 and 7.5, the temperature of the nutrient rich fluid can range from 15° C. to 35° C., and the E_{c} of the nutrient rich fluid in the biofilter media can range from approximately 0 to 3.6. Once the concentration of nitrogen (i.e., as part of the nitrate molecules) of the feed reaches 30 ppm to 200 ppm, the feed can be moved to a holding tank for later use. The system may contain sensors (e.g., the sensor system 126, the sensors 134) for periodic or continual measurement of levels of ammonium (NH₄⁺) or ammonia (NH₃), nitrite (NO₂⁻), nitrate (NO₃⁻), electrical conductivity, oxygen, and pH level, or these parameters may be measured at a specific time point.

Another embodiment of the system and method provides maximum oxygen (O₂) to the microbiological colonies of the biofilter media in relation to the set temperature within the system and the feed flow through the system. The set temperature can range from 15° C. to 35° C. and the O₂ levels can range from 5 ppm to 15 ppm. The oxygen level is critical to ensure the aerobic conditions of the biofilter media to promote the nitrification process, and the system maximizes available oxygen to ensure sufficient available O₂ and NH₄⁺ sources to facilitate the chemical reactions necessary to produce the desired nitrate.

Oxygen levels are measured via an O₂ sensor and are placed in various locations in the system, including in the biofilter media as well as in the water and nitrogen feed supply. Oxygenation is one key to the aerobic process of producing nitrate from ammonia or ammonium and permitting optimal microbial growth. This increase in oxygenation facilities more efficient chemical reactions, which results in an increased rate of nitrate generation.

In practice then, the ammonium/nitrite balance is monitored for optimal nitrate formation. If ammonia or ammonium exceeds recommended values, namely a preferred maximum of 50 ppm, or alternately nitrate exceeds a maximum of about 10 ppm, nitrate production and optimal maintenance of the nitrifying bacterial colonies may be compromised and can be adjusted in real-time through the system.

According to one embodiment, a stream of the feed containing ammonium ions is applied to the biofilter media from the top of the system. The feed passes through the biofilter media; however, the feed is retained within the biofilter media for a period of time. While the feed is retained in the biofilter media, a plurality of applicable sensors monitor ammonium (NH₄⁺), nitrite (NO₂⁻), nitrate (NO₃⁻), oxygen, electrical conductivity, and pH levels and values. As the ammonia in the feed is converted to nitrate, the depletion of ammonia and the corresponding increase in nitrate can be determined by monitoring the E_{c} and pH values. The water may be recycled into the system. When specified values are achieved for E_{c} and pH values, the feed in the biofilter media (which is now nitrate enriched and called nutrient rich fluid) is directed out of the biofilter media and out of the system. The nutrient rich fluid is now an irrigation fluid that is highly beneficial when applied to growing plants. The fluid may be directed immediately to the growing area to irrigate plants or directed to a holding tank where other organic ions and/or nutrients are added to the irrigation fluid to further enrich the irrigation fluid prior to application to plants.

This system provides real-time management of the biofilter media and the fluid in the biofilter media based on sensors to detect these levels of ammonium (NH₄⁺), nitrite (NO₂⁻), nitrate (NO₃⁻), oxygen, electrical conductivity, and pH or a combination thereof, which provide the necessary data to determine when to remove the nutrient rich fluid from the biofilter media. Likewise, sensors can be used to measure similar properties of the enriched irrigation fluid in holding tanks, and analysis if such properties can determine when direct irrigation fluid from the holding tank to irrigate plants.

In one embodiment, the nitrate forming and delivery system 800 may process and nitrate enrich a volume of 2 cubic meters (m³) to 8 m³ of water in a 4 hour period. Such enrichment of the feed can be achieved by continuously cycling the feed through the system or by a process of filling the biofilter media with water for a period of time and at operating conditions as described above. The biofilter media is modular in nature, which permits addition and removal of the total number of biofilter media layers or size of the biofilter media layer to facilitate a desired output of nitrate enriched irrigation fluid from the system.

In one embodiment, the biofilter media are maintained under conditions that both favor growth and maintenance of colonies of nitrifying bacteria but discourage growth of non-nitrifying microorganisms, such as decomposers that are effective at decomposing organic material. Because of the multiplication rate of decomposers is significantly greater than nitrifying bacteria, if the growth of decomposers is not controlled and contained, the decomposers can overwhelm the nitrifying bacteria and cause inefficiencies in the nitrate forming and delivery system 800, or even result in the nitrate forming and delivery system 800 ceasing to from nitrate.

In some embodiments, the Nitrosomonas is first introduced to the biofilter media and grows and colonizes the biofilter media. After a sufficient period of time, Nitrobacter is introduced to the biofilter media and additionally colonies the biofilter media. The composition of the feed introduced into the system changes as it is cycled through the biofilter.

As discussed above, certain parameters and characteristic of the nitrate forming and delivery system can be measured by sensors, including E_{c}, pH, Nitrogen, and Oxygen sensors. Such sensors are included in the sensor system 126 that communicates readings and measurements to a programmable logic controller (e.g., the controller 120) that controls various activities within the nitrate forming and delivery system 800. For example, an E_{c} sensor and pH sensor can be placed in the biofilter media or a holding tank. The E_{c} and pH sensors can gather continuous or periodic measurements and communicate such measurements to a programmable logic controller. The programmable logic controller analyzes the E_{c} and pH measurements and dynamically makes a determination on when to direct the irrigation fluid out of the biofilter media or the holding tank. These sensors may be used for continuous monitoring or used to assess the conditions in various location in the system at pre-set intervals. At the initiation of an enrichment cycle or during an enrichment, if homeostasis is not present, the conditions of the system can be modified by the programmable logic controller to achieve or re-achieve a homeostasis condition. The relationship between various parameters and/or characteristics of the nitrate forming and delivery system 800 is discussed further below.

One factor that influences the performance of the nitrate forming and delivery system is the pH level, which can influence the multiplication and/or lifespan of bacteria within the system. If the pH level is above or below a preferred range, the multiplying of bacteria will be slowed. If the pH level is excessively high or low, the bacteria can die. To achieve the desired results, the range of the pH in the system is maintained at between 5 and 7.5.

The rate at which bacteria multiples varies based on the type of bacteria. The decomposing bacteria multiply very quickly, approximately every twenty minutes, while the nitrifying bacteria multiples about every twenty-four hours. Decomposers will continue to multiply provided there is organic material to decompose and therefore should be removed or minimized. The system is structured to permit the segregation of the different bacteria to maintain balance in the system. For example, the amount of organic material placed into the system can be strictly monitored and controlled such that there is a sufficient amount of ammonium produced to feed the nitrate enriching process, but not enough for the decomposers to overwhelm the nitrifying bacteria.

Multiple processes may be used to form an ammonia and water mixture (i.e., the feed) to cascade onto the biofilter media for the production of nitrate. As an example, a slurry of fermented material from which solid particles have been removed and methane gas has dissipated may serve and a source of an effective ammonia and water mixture. Alternatively, processes for washing ammonia from air infused with ammonia due to certain environmental conditions can be used as a source of ammonia. Examples of environmental conditions that infuse air with ammonia include area where animal manure is present, particularly enclosed areas. Manure produced by poultry, swine, bovine, and other livestock infuse air with ammonia, particularly when such livestock is housed within an enclosed structure. Siphoning such ammonia infused air from such livestock enclosures can serve as an effective source of ammonia to blend with water and feed a nitrate forming and delivery system. Yet another process includes products fermented from a waste stream that includes fresh cut organic matter suitable for decomposition. The slurry of such products is heated, where the nitrogen remains in gas form. When this gas is chilled, the concentrate will consist of pure ammonium, which can be combined with water and fed into a nitrate forming and delivery system. Numerous other means for providing a composition of water and ammonia or ammonium are also useful for preparing a solution to be applied to the biofilter media and will result in production of nitrate.

As the process continues, the feed that picks up nitrate as it passes over the biofilter media can be transferred to a holding tank, creating a stock solution of nitrate rich fluid or slurry. One important characteristic of this stock solution is the electrical conductivity of the solution. The electric conductivity of the solution estimates the total amount of solids dissolved in water (TDS). The TDS is measured in parts per million or in milligrams per liter (mg/l). The electrical conductivity is a good indicator of the total salinity of the solution. When the nitrate rich fluid from the system is transferred to the holding tank, the stock solution of nutrients typically has an electrical conductivity that is higher than what will be sent to the growing environment to irrigate the soil and plants. To adjust, other elements, such as phosphate, will be deposited into the stock solution and optionally agitated until an appropriate balance of nutrients is achieved. Prior to transferring the irrigation fluid to the plants, the stock solution may be diluted with water as necessary to lower the electrical conductivity to approximately 2 or further concentrated (if required) to achieve the electrical conductivity to approximately 2.

The nitrate forming and delivery system 800 can be operated at a certain electrical conductivity level by introducing a fermented organic fertilizer. Higher electrical conductivity can improve yields, where the optimum electrical conductivity depends on the pH level of the solution. Thus, the pH level of the solution will be determinative of how to manage the solution. A preferred pH level is 6-6.5. However, the pH of the incoming raw water can affect the process. If the incoming raw water has a high pH, then a lower pH can be used when managing the solution downstream.

In the processes described herein, the bacteria is closely managed. The system is closely monitored to make sure no unwanted bacteria colonizes within the nitrate forming and delivery system. The process is initiated by a slurry formed from a biogas (via fermentation) and/or ammonia washing, which removes methane gas (CH₄), and the associated carbon.

The distinct lines of bacteria may be kept separate and are segregated into their roles in the process. The biofilter media is dosed with ammonium at a rate of about 10 ppm to 80 ppm, or at a rate of 20-50 ppm, or about 30-50 ppm, or 40 ppm, or at a rate not to exceed about 50 ppm. If that ammonium dosing rate rises too high, the development of Nitrosomonas is inhibited, and there will not be a sufficient amount of nitrite (NO₂⁻) or nitrate (NO₃⁻). A rate of about 40 ppm of ammonium applied to the biofilter media will yield about 1 to 20 ppm, or more preferably 5-10 ppm of nitrogen dioxide. If the production of nitrogen dioxide falls below 5 ppm, the rate of ammonium dosing can be increased, and if the production of nitrogen dioxide rises above 10 ppm, the rate of ammonium dosing can be decreased. Preferably the system maintained a maximum rate of nitrogen dioxide of about 10 ppm. With the ammonium and nitrogen dioxide in balance, the production of nitrate (NO₃⁻), is maximized at about 200-300 ppm. At that point, the nutrient rich fluid can be moved to the holding tank, the system refilled with a fresh batch of a water and ammonia mixture, and the level of nitrite can be built up once again. This process can be repeated to continuously supply an organic agricultural operation with nutrient rich irrigation fluid.

As previously noted, a pH level that is too high can inhibit or stop the nitrification process and can lead to denitrification. Denitrification releases nitrogen to surrounding atmosphere in the form of ammonia and/or nitrogen gas. When ammonium is converted to nitrogen dioxide, free hydrogen ions (H⁺) are produced. These hydrogen ions will lower the pH level, which is why a nitrification process will result in a proper pH level. Monitoring the pH level can inform the user of when it is time to empty the system into the holding tank.

The controller (e.g., the controller 120) monitors, via the sensor system (e.g., the sensor system 126), the biofilter media for parameters such as, but not limited to, pH level, O₂ concentration, E_{c} level, temperature, and other parameters to control the environment to efficiently produce nutrients such as nitrate. The controller can also monitor, manage, and control other areas of the nitrate forming and delivery system and related system to facilitate an effective indoor growing environment. For example, based on the monitored parameters of the biofilter media, the controller can control an irrigation system associated with the nitrate forming and delivery system 800 or a holding tank to transfer the nutrient rich fluid exiting the nitrate forming and delivery system or stored in the holding tank to the growing area to irrigate plants. In addition to nitrate, the nutrient rich fluid can be enriched with nutrients such as, for example, phosphorus, iron, and other nutrients useful for growing plants.

In certain embodiments, the controller can determine when the biofilter media requires additional water and can control the water feed system to deliver water to the biofilter media. In certain embodiments, the controller determines a period of time from when the biofilter media is filled with water to when the biofilter media requires additional water. Based on this determined time period, the controller can then automatically fill the biofilter media with water at each interval of the determined period of time. In certain embodiments, the controller, based on the pre-selected levels of the monitored parameters (e.g., the pH level is too high or too low or the E_{c} level is too high or too low), controls the irrigation system to either deliver more water (or feed) or pause the delivery of water to the biofilter media as applicable to balance such parameters.

Thus there are numerous procedures for operation of the nitrate forming and delivery system 800. In some embodiments, an ammonium containing water flows continuously over the biofilter media and is collected. In some cases that water will be recycled to flow over the biofilter media multiple times until a desired nitrate level in the water is reached at which point the nitrate rich fluid may be placed in a holding tank. Alternatively, an ammonium containing water flows continuously over the biofilter media and is collected and placed in a holding tank. In some aspects, the biofilter media may hold an amount of ammonium containing water within the biofilter media for a specified amount of time after which nitrate containing water is collected from the biofilter media and placed in a holding tank.

For example, the controller 120 controls the nitrate forming and delivery system 800 (can be a separate system or a part of the irrigation system 124) based on the monitored parameters received from the sensor system 126 to regulate the water and nutrients (e.g., nitrate) delivered to the nursery 110 and/or the grow room 112. The parameters monitored in the nitrate forming and delivery system 800 include, but not limited to, temperature, levels of ammonium (NH₄⁺, or alternatively ammonia (NH₃)), nitrite (NO₂⁻), and nitrate (NO₃⁻), electrical conductivity (E_{c}), pH level, O₂ level, an ammonium/nitrite ratio or any combination thereof. The controller 120 controls the operation of the nitrate forming and delivery system 800, as exemplarily illustrated in FIGS. 4F-4I. For example, the controller 120 monitors and operates the transfer pump 140 to schedule the feed (e.g., nitrate enriched fluids) transfer in specific intervals and durations. For example, the controller 120 monitor and operates the nutrition injection pump 138 to schedule nutrient injection in specific intervals and durations to achieve certain targeted E_{c} and pH values. For example, the controller 120 schedules the feed (e.g., nitrate enriched fluids) transfer based on determination of whether the targeted pH value and/or the E_{c} value has been reached. For example, the controller 120 monitors and/or maintains the feed (e.g., nitrate enriched fluids) levels in various tanks for distributing nitrate to the nursery 10 and/or grow room 112.

In one embodiment, the nitrate forming and delivery system 800 can also produce ammonium. In this embodiment, the decomposer microorganism colony (e.g., bacteria or fungi) is grown in the biofilter media (e.g., 810, 830, and 850) and produces ammonium based on water and a food source. For example, the nitrate forming and delivery system 800 includes a decomposer biofilter (e.g., the biofilter media layer 810, 830, and/or 850) including a surface having growing thereupon a decomposer microorganism colony. The decomposer biofilter is maintained under conditions suitable for growth and maintenance of the decomposer microorganism colony. Water and food source can be introduced through the nozzles 880 and flow through the decomposer biofilter by gravity so that the decomposer microorganisms produce and release ammonium upon contact with the water and food source. The nitrate forming and delivery system 800 also includes a nitrifying biofilter (e.g., the biofilter media layer 810, 830, and/or 850) including a surface having growing thereupon a nitrifying microorganism colony. The nitrifying biofilter is maintained under conditions suitable for growth and maintenance of a nitrifying microorganism colony. The liquid collected from the decomposer biofilter (e.g., the liquid includes water and ammonium) is applied to the nitrifying biofilter. The liquid flows through the nitrifying biofilter by gravity so that the ammonium is accessible to the nitrifying microorganisms and the nitrifying microorganisms produce nitrate from the ammonium. The liquid containing water and nitrate is collected (e.g., by the catch basin 870). This liquid collected from the nitrifying biofilter is a liquid organic fertilizer.

In one embodiment, the method of using the nitrate forming and delivery system 800 includes preparing a liquid containing water and ammonium. This liquid can be prepared by adding ammonium to water (e.g., ammonium prepared or obtained via any approaches mentioned above) or may be prepared using the nitrate forming and delivery system 800. For example, preparing a liquid containing water and ammonium may include providing a biofilter media (e.g., the biofilter media layer 810, 830, and/or 850) including a surface growing thereupon a decomposer microorganism colony. The biofilter media is maintained under conditions suitable for growth and maintenance of the decomposer microorganism colony. The method includes adding to the biofilter media water and a food source. The water flows through the biofilter media by gravity so that the decomposer microorganisms produce ammonium. The method includes collecting (e.g., via the catch basin 870) a liquid from the biofilter containing water and ammonium.

Once the liquid containing water and ammonium is prepared, the method proceeds to preparing a liquid containing nitrate (e.g., for use in nutrient rich irrigation fluid). The method includes providing a biofilter media (e.g., the biofilter media layer 810, 830, and/or 850) including a surface growing thereupon a nitrifying microorganism colony. The biofilter media is maintained under conditions suitable for growth and maintenance of the nitrifying microorganism colony. The method includes applying the liquid containing water and ammonium to the biofilter media. The liquid flows through the biofilter media by gravity so that the ammonium is accessible to the nitrifying microorganisms and the nitrifying microorganisms producing nitrate from the ammonium. The method includes collecting (e.g., via the catch basin 870) a liquid from the biofilter media containing water and nitrate.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 702 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 608. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A system for indoor plant growing, comprising:
an environment management system comprising an air circulation system, an irrigation system, a sensor system, a lighting system, and a nitrate forming and delivery system; and
a control system communicatively and operatively coupled to the environment management system to dynamically control operations of the environment management system based on a feedback and control loop comprising micro and macro data from plant growing zones.

2. The system of claim 1, wherein the control system is configured to dynamically control and update a localized environment at cultivation pots based on a determination of the micro data.

3. The system of claim 1, wherein the air circulation system is configured to adjust humidity and/or temperature underneath a plant canopy.

4. The system of claim 1, wherein the air circulation system is configured to control localized air circulation at cultivation pots.

5. The system of claim 1, wherein the sensor system is configured to monitor the micro data comprising localized environment conditions at cultivation pots.

6. The system of claim 1, wherein the plant growing zones comprise a plate configured to support cultivation pots, and the plate comprises ventilation features comprising gutter, cavities, or both.

7. The system of claim 1, wherein the nitrate forming and delivery system comprises:
exterior walls;
biofilter media enclosed within the exterior walls, wherein the biofilter media is suitable for colonization of nitrifying microorganisms or colonization of decomposer microorganisms;
at least one colony of the nitrifying microorganisms grown on the biofilter media;
a drain;
a catch basin; and
nozzles for dispensing a liquid across the top of the biofilter media, the liquid flowing through the biofilter media and exiting at the drain and collecting in the catch basin,
wherein the nitrate forming and delivery system is maintained under conditions permitting growth and maintenance of the at least one colony of the nitrifying microorganisms.

8. The system of claim 7, wherein the nitrifying microorganisms comprise Nitrosomonas and Nitrobacter microorganisms.

9. The system of claim 7, wherein the biofilter media layer comprises multiple surfaces, each suitable for colonization by multiple colonies of the nitrifying microorganisms, wherein each surface is accessible independent of other surfaces through a shelving system.

10. The system of claim 7, wherein the nitrate forming and delivery system comprises a pump that cycles the liquid collected at the catch basin to be dispensed by the nozzles.

11. The system of claim 7, wherein the control system monitors and operates the nitrate forming and delivery system to deliver the collected liquid comprising water and nitrate to the plant growing zones.

12. The system of claim 7, wherein the sensor system is configured to monitor parameters of the liquid, the parameters comprising: levels of ammonium, nitrite, nitrate, electrical conductivity, pH level, O₂ level, or combinations thereof.

13. The system of claim 7, wherein at least one colony of the decomposer microorganisms grown on the biofilter media.

14. A system for production of a liquid organic fertilizer comprising:
a means for producing a liquid comprising water and ammonium, the means comprising:
providing a decomposer biofilter comprising a surface having growing thereupon a decomposer microorganism colony, the biofilter maintained under conditions suitable for growth and maintenance of the decomposer microorganism colony;
adding to the biofilter, water and food source, wherein the water and food source flows through the biofilter by gravity so that the decomposer microorganism colony produce and release ammonium upon contact with the water and food source; and
collecting the liquid comprising water and ammonium from the decomposer biofilter;
a means for producing a liquid comprising water and nitrate, the means comprising:
providing a nitrifying biofilter comprising a surface having growing thereupon a nitrifying microorganism colony, the biofilter maintained under conditions suitable for growth and maintenance of the nitrifying microorganism colony;
adding to the nitrifying biofilter the liquid comprising water and ammonium collected from the decomposer biofilter, wherein the liquid flows through the nitrifying biofilter by gravity so that the ammonium is accessible to the nitrifying microorganism colony and the nitrifying microorganism colony producing nitrate from the ammonium; and
collecting a liquid comprising water and nitrate from the nitrifying biofilter;
wherein the content of the liquid collected from the nitrifying biofilter is the liquid organic fertilizer.

15. A method of operating a system for indoor plant growing, comprising:
growing plants in an indoor plant growing zone;
collecting and analyzing environment data;
determining localized environment conditions; and
updating the operation of the system dynamically based on the determination of the localized environment conditions.

16. The method of claim 15, comprising generating and delivering an organic liquid fertilizer to the indoor plant growing zone.

17. The method of claim 16, wherein generating the organic liquid fertilizer comprises:
providing a biofilter media comprising a surface having growing thereupon nitrifying microorganisms, wherein the biofilter media is maintained under conditions suitable for growth and maintenance of the nitrifying microorganisms;
applying a liquid comprising water and ammonium to the biofilter media, wherein the liquid flows through the biofilter media by gravity so that the ammonium is accessible to the nitrifying microorganisms and the nitrifying microorganisms producing nitrate from the ammonium; and
collecting the organic liquid fertilizer comprising water and nitrate.

18. The method of claim 17, further comprising preparing the liquid comprising water and ammonium by:
providing a biofilter media comprising a surface having growing thereupon decomposer microorganisms, wherein the biofilter media is maintained under conditions suitable for growth and maintenance of the decomposer microorganisms;
adding to the biofilter media water and a food source, wherein the water flows through the biofilter media by gravity so that the decomposer microorganisms produce ammonium; and
collecting the water and ammonium.

19. The method of claim 17, comprising maintaining the biofilter media at 20° C. to 28° C.

20. The method of claim 17, comprising maintaining the liquid at a pH of about 5 to 5.5.
